(19) United States
(12) Patent Application Publication
(10) Pub. No.: US 2002/0169702 A1
(43) Pub. Date: Nov. 14, 2002

(54) Methods and systems for financial planning

(76) Inventors: Robert G. Eaton JR., Glen Carbon, IL (US); Charles H. Devers, Krikwood, MO (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 10/125,152

(22) Filed: Apr. 18, 2002

Related U.S. Application Data
(60) Provisional application No. 60/284,909, filed on Apr. 19, 2001.

(51) Int. Cl. G06F 17/60

(52) U.S. Cl. 705/36

(57) ABSTRACT

A method for increasing after tax income is disclosed which includes obtaining a mortgage on equity in real property, the mortgage having an annual interest amount and receiving substantially equal annual distributions from an individual retirement account that are approximately equal to the annual interest amount on the mortgage. The method also includes paying the mortgage interest with the IRA distributions, placing the received equity in a money management account, transferring funds from the money management account into a life insurance contract over a set period, and receiving tax advantaged distributions from the life insurance contract.

### CROSS REFERENCE TO RELATED APPLICATIONS

This application claims the benefit of U.S. Provisional Application No. 60/284,909, filed Apr. 19, 2001.

### BACKGROUND OF THE INVENTION

This invention relates generally to the processing of data, and more specifically to, processing systems and methods which provide paperless services and storage of data for financial transactions.

Many of the financial services industries, for example, insurance, are largely form based. That is, when a prospective client wishes to apply for an insurance policy, an agent, along with the clients help, has to fill out a paper application form, which is then sent to a home office of the insurance company for underwriting, and hopefully issuance of a new insurance policy. Some of these transactions have become computer based, and the applications are electronically uploaded to the home office. However, the computer has simply replaced the paper form, the agent or representative has to enter all of the pertinent data for the client. The computer based process simply eliminates the paper form and the mailing or faxing of the form to the home office.

Some applications are known which are a bit more sophisticated. For example, some insurance companies store databases of client (insured) and agent data. When a policy is added, updated, or another change is desired, the database can be accessed by the agent, and a large portion of the client data can be downloaded from the database. That is, the agent does not have to reenter certain known data, for example, name address, and social security number for a client again and again.

Certain insurance agents are considered to be captive agents. That is they only represent one insurance carrier. However, most agents are considered to be independent agents, and they may represent a number of companies. Further those companies may provide a large number of services ranging from simple auto insurance to various types of life insurance to investment services and retirement planning, which may include offering of regulated securities. Further, agents have to be registered within each state in which they conduct business, and the various states may require different information when a client is making any of the above described purchases.

Therefore, an agent is inundated with different forms, be they paper or computer based. Also, the various companies which an agent represents typically employ proprietary systems and no sharing of client information can take place between the proprietary systems. So, based on what products a client may wish to purchase, an agent is still typically required to enter client information, again and again.

### BRIEF DESCRIPTION OF THE INVENTION

In one aspect a method for increasing after tax income is provided. The method comprises obtaining a mortgage on equity in real property, the mortgage having an annual interest amount and receiving substantially equal annual distributions from an individual retirement account that are approximately equal to the annual interest amount on the mortgage. The method further comprises paying the mortgage interest with the IRA distributions, placing the received equity in a money management account, transferring funds from the money management account into a life insurance contract over a set period, and receiving tax advantaged distributions from the life insurance contract.

In another aspect, a computer program product for use with a computer system is provided. The computer program product comprising a computer usable medium having code stored thereon comprising program code for matching equity in real property against assets in IRA accounts, program code for illustrating how withdrawals from the IRA can be used to pay a mortgage taken on the equity in real property, and program code for illustrating how proceeds from the taken mortgage can be utilized in a tax advantaged insurance product.

In still another aspect, a financial planning system is provided which comprises a database of customer financial and demographic data, a database server configured to write data to and read data from the database, and a computer configured to access the database server. The database server is further configured to match equity in the real property of a customer against assets in IRA accounts of the customer, illustrate how substantially equal withdrawals from the IRA over a set period can be used to pay a mortgage taken on the equity in the real property, and illustrate how proceeds from the taken mortgage can be utilized in a tax advantaged insurance product to increase after tax income.

### BRIEF DESCRIPTION OF THE DRAWINGS

FIG. 1 is a system diagram.

FIG. 2 is a flow diagram illustrating a virtual assistant process.

FIG. 3 is a continuation of the flow diagram of FIG. 2.

FIG. 4 is a continuation of the flow diagram of FIG. 3.

FIG. 5 is an example home page for accessing the virtual assistant process of FIGS. 2-4.

FIG. 6A is a page illustrating a profile for a client of a paid subscription user.

FIG. 6B is a page listing the clients of a paid subscription user.

FIG. 6C is a page illustrating selections for updating a client profile.

FIG. 7 is a page illustrating a vendors list for a selected product type for a paid subscription user.

FIG. 8 is a page illustrating how a paid subscription user can select products from a selected vendor.

FIG. 9 is a page illustrating which forms are required and optional for a selected product from a selected vendor.

FIG. 10 is a page illustrating which of the selected forms from FIG. 9 can be completed utilizing stored client data.

FIG. 11 illustrates a financial planning method.

FIG. 12 is a page illustrating inputs needed to evaluate financial strategies.

FIG. 13 is an illustration of financial planning scenarios.

FIG. 14 is an illustration of a mortgage type selection page.

FIG. 15 is an illustration of a property information and loan purpose page,

FIGS. 16 and 17 are an illustration of a page for entry of borrower and co-borrower information.

FIGS. 18 and 19 are an illustration of a page for entry of borrower and co-borrower employment information.

FIG. 20 is an illustration of a page for entry of income and housing expenses information.

FIGS. 21-23 are an illustration of a page for entry of asset and liability information.

FIG. 24 is an illustration of a page for estimation of expenses associated with a real estate transaction.

FIG. 25 is an illustration of a declarations page.

FIG. 26 is an illustration of a governmental monitoring page.

FIG. 27 is an illustration of a continuation sheet.

FIG. 28 is an illustration of a page for selection of mortgage and insurance products.

FIGS. 29-39 are illustrations of pages utilized for insurance product applications.

### DETAILED DESCRIPTION OF THE INVENTION

The features and principles of the present invention will now be described relative to an exemplary embodiment thereof. It will be apparent to those skilled in the art that numerous variations or modifications may be made to the exemplary embodiment without departing from the spirit and scope of the present invention. The system and method are not limited to the specific embodiments described herein. Components of each system and method can be practiced independent and separate from other components and methods. Each system and method also can be used in combination with other components and methods.

Referred to herein is a virtual assistant which is, in one embodiment, a hub to a suite of programs further described herein, although not necessarily described as programs. The virtual assistant includes an advanced database management system which captures, in a centralized database and in one embodiment, pertinent financial and demographic information collected by independent financial consultants. The database allows the independent financial consultants to select any number of financial services, including, but not limited to, mortgage products, life and health insurance policies, annuities, mutual funds and similar financial products, including property casualty insurance products. Upon selection of a product, the virtual assistant will cause needed information for a specific product application to be automatically compiled from the database, and request any additional information needed for the product application which is not already included within the database. The newly added information will also become a part of the database, since that particular and newly entered information may be required for future new product purchases, for example, insurance applications. Therefore, the virtual assistant provides an automated mechanism for the completion of what is sometimes referred to as the “paperwork” required to make applications for any one or more of the above listed products. The above listed applications should not be considered limiting, in that the technology may have further applications in other fields, for example, medical claims processing and loan processing.

The database management system packages the information, both the newly entered and that retrieved from the database, and sends it to a party, for example an insurance carrier, in the form or format that they request. Some typical formats include a formatted data stream, encrypted e-mail, encrypted zip file, or a fax document. For product applications that require a signed original or printed copies for the client (insurance applicant), the database management system completes the application forms for any given product using an on-line forms completion technology that meshes the client financial information into the requisite financial application forms for any of a number of financial service providers. The database management system therefore meets requirements of any given financial services provider, including those that require manual signatures.

In one embodiment, an interface to the virtual assistant and the rest of the database management system is achieved through an Internet web site, sometimes referred to as a homepage, by registered subscribers, who are typically representatives for one or more of the financial services companies that offer the services which are listed above. The below described system therefore allows an independent financial services professional, (i.e. the registered subscriber), to maintain all of his or her client's personal and confidential financial records in a centralized database which also maintains the data formatting requirements for a number of financial services providers. In one embodiment, only the registered subscriber for a particular client can gain access to that client's data, unless such access shall further provide access to a specifically described 3^{rd} party that might, for example, include a statutory, a regulatory, or a contractually agreed-upon party.

The system includes security provisions that ensure that all data transmissions are maintained in a secure environment. Any printed output of the financial services forms is likewise transmitted back to the registered subscriber in a highly secure network environment to ensure that a data packet representative of the final product cannot be hacked or inadvertently transmitted to the wrong end-user. Should a transmission to a wrong end-user occur, the data packet cannot be opened or viewed, which is an important consideration for complying with various confidential personal data regulations under existing federal law, including the Graham-Leach Act and Health Information Personal Privacy Act (HIPPA).

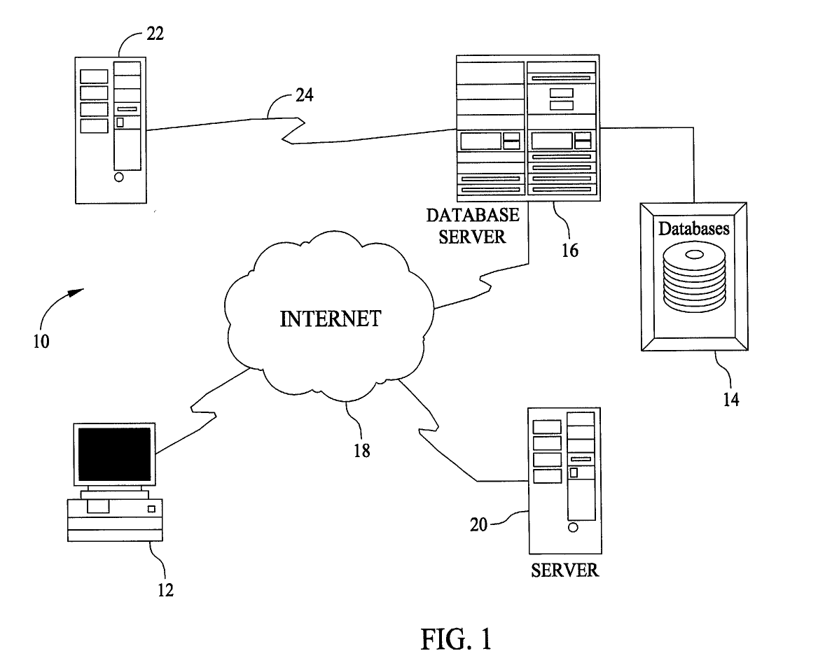

FIG. 1 is one embodiment of a database management system 10 which is configured to provide the above described functionalities. System 10 includes a registered subscriber computer 12, databases 14, and a database server 16. Computer 12 is able to access database server 16, and therefore databases 14, via the Internet 18. As is further described below, a server 20, for example, located at a provider of insurance products, is also connected to Internet 18. The connection of server 20 to Internet 18 provides a mechanism for communications between computer 12 and server 20, and database server 16 and server 20 as further described in the methods below. A provider system 22 is also shown in FIG. 1. Provider system 22 is communicatively connected to database server 16 utilizing a secure interface 24. Provider system 22 includes the functionality of server 20, except that provider system 22 is not Internet based. In one embodiment, database server 16 is located on a fiber optic or other alternative large broadband internet network such as a satellite transmission network or other high capacity network.

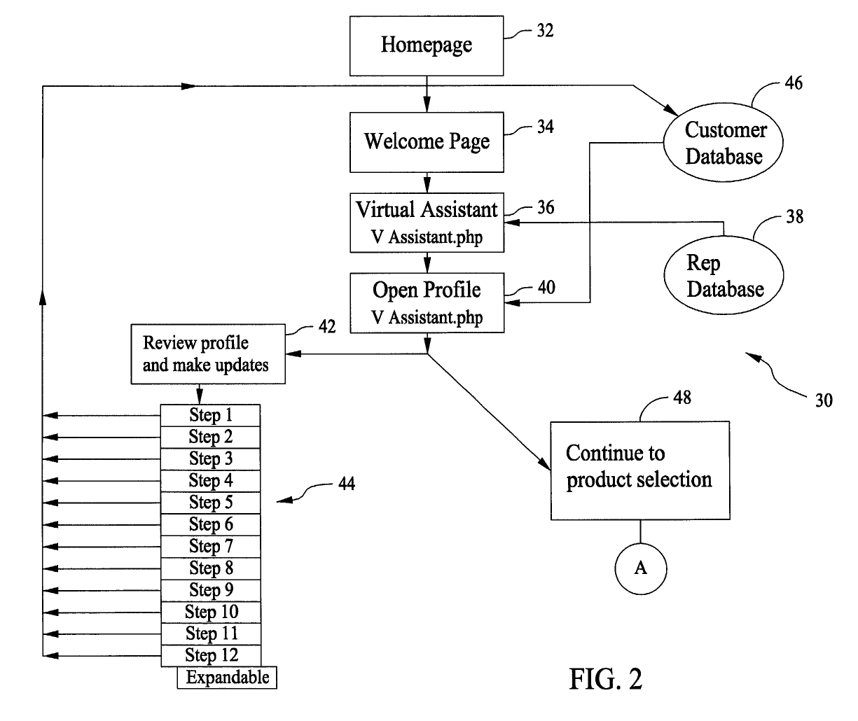

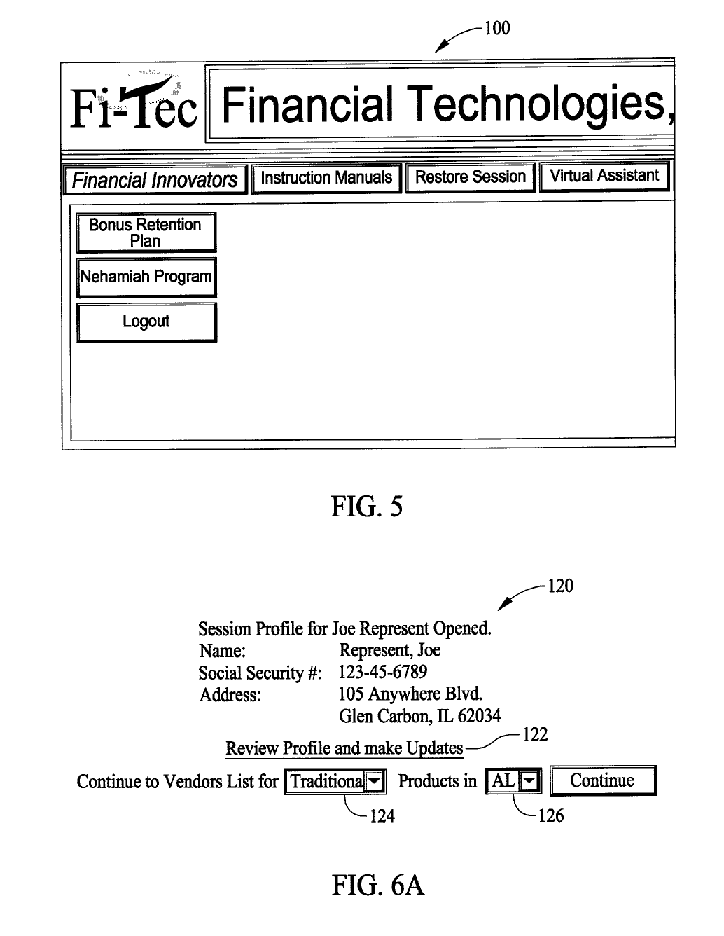

FIG. 2 is flow diagram 30 illustrating a virtual assistant process within the above described database management system 10. A registered subscriber, often referred to herein as a paid subscription user or PSU, accesses 32 a homepage which provides an entry point to database management system 10. The homepage provides an opportunity for the PSU to log in, after selection of a virtual assistant link (shown in FIG. 5). When the PSU logs in using the internet-based homepage, software within database server 16 examines information pertaining to the PSU which is stored within database 14 (shown in FIG. 1) to determine whether the PSU has paid subscription fees through the current period and what specific product platforms the PSU has paid subscription fees to use. If the subscription fees are paid, a session is opened for the PSU. The product check is performed against a master PSU database, within databases 14, that contains an inventory of all states and financial products for which the PSU is licensed to conduct business. The master PSU database further contains subscription data for the PSU. For example, if the PSU is a mortgage broker, they would not subscribe to an insurance support product, while such an insurance support product would probably be the product of choice for a PSU who is an independent insurance agent.

Once the determinations regarding the PSU have been made, database server 16 causes a welcome page to be displayed 34 at computer 12 of the PSU. From the welcome page, the PSU is able to select 36 a virtual assistant. The virtual assistant, upon selection, retrieves a table of clients for the PSU from representative database 38, which is included within databases 14. The PSU is able to select a client from the listing of clients, thereby causing a profile for the selected client to be opened 40. Once the PSU has opened 40 a profile for a client, then database server 16 causes a client screen to be displayed at PSUs computer 12, the screen is sometimes referred to as a Virtual Assistant Profile Screen.

From the Virtual Assistant Profile Screen the PSU may determine that a review profile and make update session should be selected 42. Such a selection would be typical if a long time had passed since a client/customer had met with the PSU or there had been a material change in the affairs of the PSU's client. The virtual assistant is configured to open 44 a series of fields to allows the PSU to update the profile of the client. Such updates are then stored in customer database 46, which is also within databases 14. The updates may be updates to previously stored data, or new data. Updating the client profile is an expandable process, meaning that additional client profile fields (or “steps”, as depicted in the FIG. 2) may be added at a future time, without any substantial or significant alterations to the database server 16. The purpose of the fields is to allow the PSU to create a complete economic, financial, health, and credit profile of each individual client of the PSU within customer database 46. For example, a PSU desiring to write a policy of health insurance might need applicable medical information that profiles the potential client according to the needs of a health insurer. Had the client previously purchased annuities from the PSU, an up-date for the health insurance application would be cumulative to the presently existing data within database 46.

The information needed for the health insurance application may not currently be included within customer database 46. However, at least a portion of the data needed for the health insurance is available from customer database 46 based on the previous annuities purchase. The remaining information needed for the health insurance is, upon entry, added to customer database 46 through utilization of the virtual assistant. A sum total of all information from the client, from the annuities purchase and the health insurance, is now stored in customer database 46 and is available to the PSU for future purchases of other products, and will require less, or possibly even no data entry by the PSU since the data that has been collected may meet the needs of any new or added financial product or service. Updating a client profile creates a register of activity for the events which have taken place during the session. Therefore, customer database 46 is dynamically updated while a running log is maintained for all activity that takes place on any PSU client file within customer database 46.

The profiles for each client correspond to information that, at least in some known systems, would typically be maintained by the PSU in a paper-based file for use by a PSU in meeting the service needs of a client for any given financial product.

Once the PSU has determined that the client's profile is properly updated, the PSU exits the review profile and make updates session, and the PSU is again presented with a screen for opening 40 a profile. The act of ending the review profile and make updates session has an effect of updating customer database 46. Customer database 46 is the repository of all client profiles for all PSU's using database management system 10. Customer database 46, in one embodiment, is accessed by a PSU solely and only for those specific clients under the direct control of the PSU. In such an embodiment, the PSU cannot access any other PSU client profiles despite the fact that all client profiles are held in a single, common database, that is customer database 46.

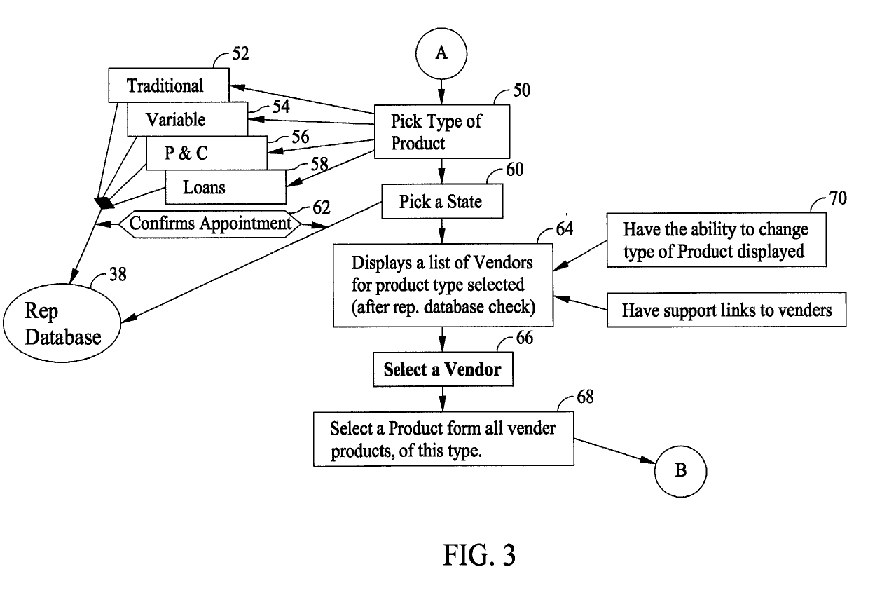

Within the open profile screen, the PSU is prompted 48 to select a product type. Product types include insurance, in one embodiment, inclusive of traditional, variable, property and casualty products, and loans. Although the product types refer to insurance type products, however the scope should not be construed to be so limited. Referring to FIG. 3, the PSU selects 50 a product type. In a specific embodiment, products are selected using drop down box or pull down menu as is well known in the art. As stated above, the choices, or categories, allowed in the embodiment shown are, traditional 52, variable 54, property and casualty (P&C) 56, and loans 58. These categories are generally aligned with the financial products that require specific licensure in order to be offered for sale by a representative, agent, marketing person, or loan originator such as the PSU.

Upon selection 50 by the PSU of one of the categories, database server 16 is configured to examine data within representative database 38 to determine whether the PSU has access to the type of product for which access has been requested. A recognition by database server 16 that a PSU does, in fact, have access to the categorical selection next results in an internal recognition of financial product vendors for which the PSU is either licensed to sell or for which the PSU is otherwise authorized to sell. The PSU is also presented with a selection 60, for example, a pull down menu that contains a listing of all 50 states. The PSU then selects 60 a state from the pull down menu that corresponds to the state in which a client's application must, for regulatory or other purposes, be taken for the contemplated product purchase. Again, database server 16 makes an internal review of representative database 38 to confirm 62 whether the PSU is licensed within the state which has been selected 60 for the product that previously was selected 50. For example, the check determines whether the PSU might offer a specific insurance company product for a specific state. The product offerings presented to the PSU are a direct result of the PSU's licensing and appointments to do business in any given state.

In one embodiment, representative database 38 and customer database 46 are under exclusive control of the provider of database server 16, and the information contained within cannot be accessed, modified or deleted by any other party.

Once database server 16 has verified the PSU is licensed for the selected 50 product type in the selected 60 state, database server 16 causes to be displayed on the PSUs computer 12 a screen that displays 64 a list of vendors for product type selected, for example, Company, A, Company B, and Company C. (see also Figure below). In one embodiment, should the PSU wish to modify the selection 50 of a product type, the page which displays the list of vendors is configured to allow the PSU to modify such a selection. In a specific embodiment, the PSU may access a listing of all product types available for selection through a pull down menu. In another specific embodiment, a choice by the PSU to amend the product type selected results in database server 16 forcing the PSU to reopen the customers profile and repeat the selections of a product and a state as outlined above.

When the PSU selects 66 a specific vendor from the listing of available choices, in one embodiment, by selecting an icon of the specific vendor, the PSU is presented a page that allows the PSU to select 68 a specific group of products within the previously selected product type offered by the selected 66 vendor. In one embodiment, the selection 68 is made through a pull down menu that contains each product offered for sale by the selected vendor.

The act of selecting 68 a product by the PSU next causes database server 16 to link to a database of information for the selected vendor. The selected vendor's information database is not maintained as part of database server 16, rather, it is instead maintained by the vendor itself, for example within server 20 or provider system 22. The linking to the vendor database serves to provide database server 16 with a list of forms that are required and optional for the selected product. Linking, in one embodiment, takes place via Internet 18, and is directed by database server 16. In another embodiment, database server 16 directs a connection to provider system 22 over secure interface 24. The PSU takes no action to control the linking or connecting process.

The PSU may elect to either continue with the specific product offering that was selected 68 or, alternatively, to abandon pursuing that specific product in order to make a different 70 product selection. In the event the PSU chooses to select a different 70 policy or product, database server 16 automatically re-directs the PSU to select 68 a different product as previously described.

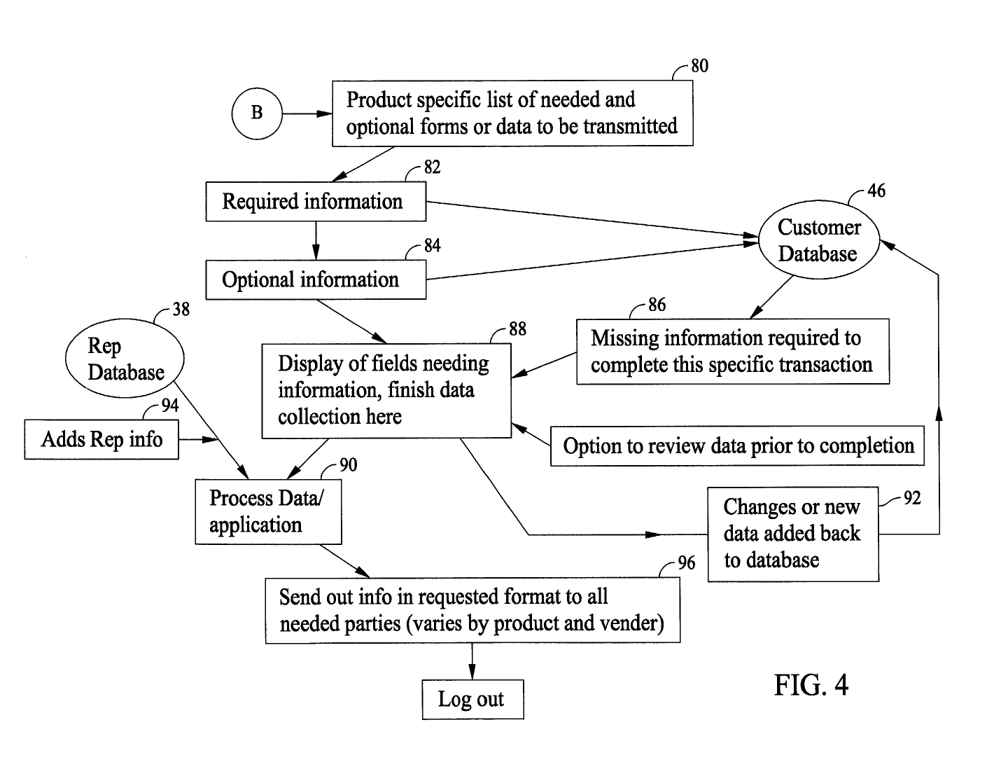

Referring to FIG. 4, in the event the PSU determines to continue with the policy or product selection 68 (shown in FIG. 3), then the PSU is directed 80 to a product specific list of needed and optional forms or data to be transmitted to secure the selected product for the client.

For certain product purchases there are one or more required forms for which required information 82 is needed for completion. For these products there also may be one or more optional forms for which at least some optional information 84 is needed for completion. Within each category, required or optional, individual forms may be selected. During the forms selection process, database server 16 is configured to, and without any intervention by the PSU, access a series of product databases within databases 14. In one embodiment, database server 16 forms a list of the information needed to complete all selected forms, both required and optional, and then accesses database 14 to determine if all the information in the list exists in the client file within customer database 46. In the event that customer database 46 includes all the information needed to complete the selected forms, database server 16 presents the PSU with a screen showing all of the forms that are currently able to be processed.

In the event that information needed for any of the forms is missing 86 from customer database 46, database server 16 is configured to present to the PSU a screen which displays 88 information fields that are missing from customer database 46 that is needed to complete the selected forms for the particular client. The information fields, in one embodiment allow the PSU to enter the missing information. The actual screen that is presented to the PSU is unique for the PSU's present situation, meaning that a listing of additional required information appears, depending upon the exact information requirements that remain unmet, and the data that is currently resident within customer database 46.

Once the PSU enters the missing information, the PSU may select to process 90 the data and apply for the financial product. In one embodiment, and without any intervention by the PSU, the additional information entered, including any changes, are added 92 to customer database 46. Therefore, customer database 46 is updated with all finalized information, based on the product application, and the data is date and time stamped for internal tracking purposes, billing purposes, and to create a permanent record of the transaction. The permanent record may be used for purposes of verifying compliance with applicable rules, regulations, and statutes that may govern the issuance of the type of financial product sold. The data may also be applicable to any future transactions between the PSU and the client.

Once all the information needed, both required and optional, is gathered, the PSU has an option of whether to review 94 the information which will be used to complete the required and optional product application forms. To complete processing of the application, a listing of forms that have been readied for final processing is presented to the PSU. Should the PSU choose to proceed, the forms will be generated which are used to apply for the selected financial product. Database server 16 is configured to access representative database 38 to generate 94 the personal identification needed to process the financial product at the vendor level (e.g. an agent insurance I.D. will be appended to the date and/or forms to be submitted). The personal identification procedure also works to ensure that the PSU will receive his or her commission.

Database server 16 is further configured to create and distribute 96 data and forms that will be used to direct, define, and ultimately to transmit and distribute the completed data and forms. Although referred to herein as forms, it is to be understood that forms encompasses all methods of getting the client information to the product vendor (provider). In alternative embodiments, the methods include, but are not limited to, formatting data streams to be received at server 20 or provider system 22 in a defined format, an encrypted E-mail to the product provider, a zip type file sent to the product provider, generation of actual paper forms to be sent to the provider, and the sending of a facsimile to the provider. Regarding the generation of paper forms, for products that require signed original or printed copies for the client, database server 16 completes the application forms for the selected product by meshing the client information in customer database 46 with requisite financial application forms for the vendor.

In one embodiment, after product application data has been sent to the provider of the financial product, database server 16 is configured to display an E-mail notification message on PSU computer 12. The E-mail notification message serves as an indication to the PSU that all of the data and/or forms have been processed and may be retrieved immediately through an e-mail system which is supported by database server 12. After the notification, PSU computer 12 is routed to the homepage 32, and the PSU may initiate another financial product purchase.

The above described methods and system configurations are better understood when their teachings are combined with the following displays which database server 16 causes to be displayed at PSU computer 12 (both shown in FIG. 1).

FIG. 5 is an example of a homepage 100, which includes a link to a virtual assistant process which is described above with respect to FIGS. 2-4. Upon selection of the virtual assistant link, system 10, and specifically database server 16, after a successful login by a PSU from a welcome page, causes a session profile to be started.

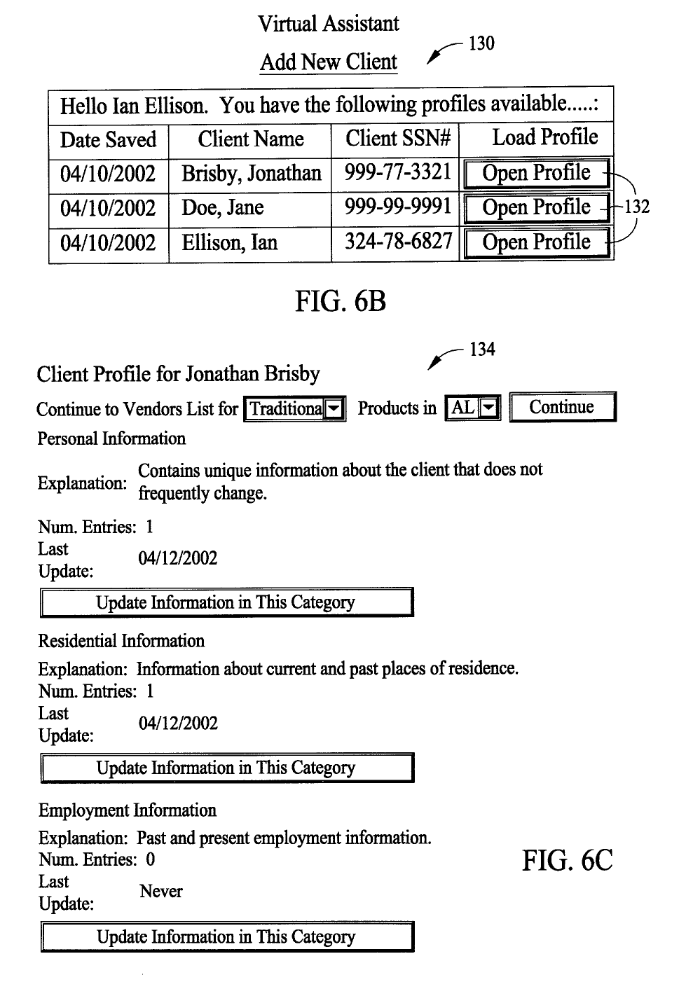

FIG. 6A is one example of an open profile screen 120 which is displayed at PSU computer 12 after a successful login. Screen 120 contains, in the embodiment shown, a profile for the client including name, address, and social security number. Screen 120 further includes a selectable link 122 which the PSU may select to update the client profile, for example, a simple address change. Screen 120 allows the PSU to select from a list of products the PSU is authorized to sell for each particular vendor, and further select the states where the PSU is authorized to sell each individual product. Screen 120 includes a link 124 where the PSU can select from the types of products they are authorized to sell, and a link for selecting a state for the product sale. In one embodiment, link 126 is configured to only allow selection of a state where the PSU is licensed.

FIG. 6B is a page 130 illustrating an alternative way for a PSU to select a client profile, that is, from a listing of current clients. Page 130 includes buttons 132 which can be selected by the PSU to display a profile for a client which can then be updated.

FIG. 6C is a page 134 illustrating a client profile for a client that was selecting, for example, from page 130 (shown in FIG. 6B). In the embodiment of page 134 shown, the PSU is able to make selections for updating different portions of the selected client profile, for example, personal information, residential information, and employment information. The PSU, from page 134 is able to select links for selecting the types of products they are authorized to sell and for selecting a state for the product sale, similar to the selections described in FIG. 6A. It should be understood that the embodiments shown in FIGS. 6A, 6B, and 6C are examples only. Many other combinations for selecting and updating client profiles utilizing selectable pages are thought to be within the scope of the description herein.

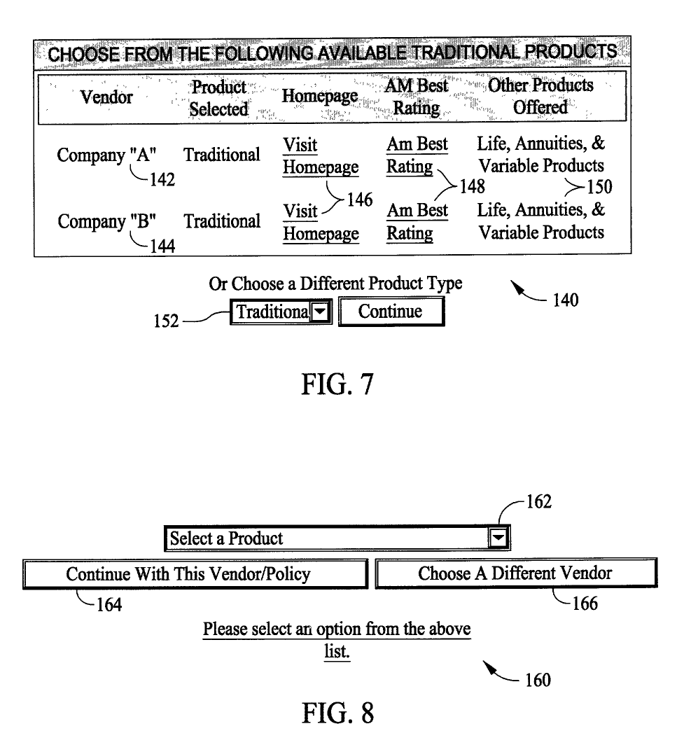

Upon completion of a product type selection and state from screen 120 or screen 134, the PSU is presented with a vendor selection screen 140, shown in FIG. 7. Screen 140 allows the PSU to select from which vendor they wish to purchase the previously selected product type, for example, by selecting one of Company “A” logo 142 or Company “B” logo 144. Other selections available from screen 140 include links 146 to each of the vendors home web sites and a selection 148 to view ratings on each of the vendors by well known rating services. Screen 140 further displays the types 150 of products offered by each of the individual vendors. Screen 140 further includes a link 152 where the PSU may choose to select a different product type, as described above in making a different 70 product selection (shown in FIG. 3).

FIG. 8 illustrates a product selection screen 160. In the embodiment shown, a pull down menu 162 allows the PSU to select a product from the previously selected vendor. For example, traditional products could include, but are not limited to, term life insurance of different terms (i.e. 10, 20, and 30 years), whole life insurance, and universal life insurance. Variable products may include a variable life insurance product, which typically includes securities purchases. Once a product is chosen, the PSU may select a link 164 which causes a continuation of the application process as above described for the selected product, from the selected vendor. A different vendor link 166, allows the PSU to go back and select a different vendor as described with respect to FIG. 7.

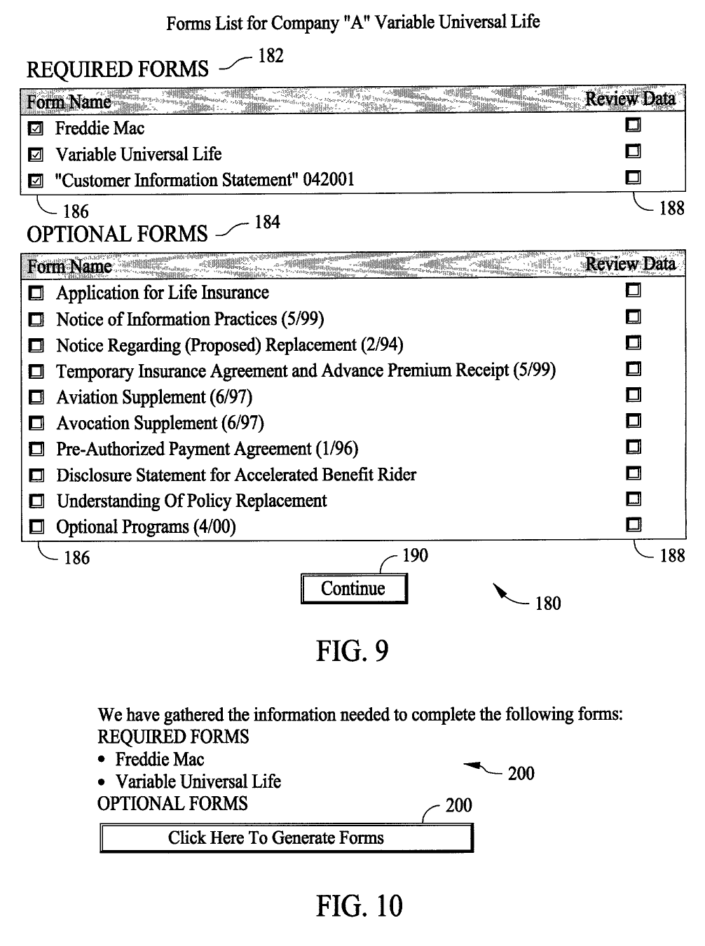

FIG. 9 is a required forms screen 180 which is displayed at PSU computer 12 upon selection of a vendor and a product as described above. Screen 180 includes a list 182 of required forms and a list 184 of optional forms which are used in applying for the selected financial product from the selected vendor. The PSU is able to select and deselect individual forms using check boxes 186 and review the data within database 14 (shown in FIG. 1) for each individual form by selection of review data check boxes 188. When continue button 190 is selected, a screen 200 (shown in FIG. 10) is generated. Screen 200 illustrates to the PSU which forms can be completed based upon the information available regarding the client in databases 14. Referring specifically to screen 200, database 14 currently contains all the client information needed to complete a “Freddie Mac 2000 Gen Am” form. By selecting button 202, information will be copied out of customer database 46 and formatted to be compatible with, for example, server 20 (shown in FIG. 1) (assuming for the moment that server 20 is the server for the vendor who has been selected by the PSU). The data is then sent to the server, and results in an application being generated for the selected financial product at server 20. As stated above, depending on the vendor, the application format may be in one of many forms, including fax, email, and hard copy.

The systems and methods described herein are considered to be unique in that the above described virtual assistant creates a single, central data repository of each and every form required by one or more financial institutions (i.e. vendors) to conduct their new business processes. While some new business processing systems are known to exist, those systems are best characterized as vendor specific. In other words, those systems are presently maintained under file management systems controlled uniquely by the financial institution for which the products were created. For example, Bank A may maintain its own mortgage application forms and customer information databases for Bank A loans, but Bank A will not have access to Bank B forms or databases, and vice versa. The outcome of the known systems is that a system user, for example, a PSU must maintain either resident file management systems or, alternatively, depend upon centralized database and file management systems of each and every vendor with which they conduct business. Therefore, the independent PSU must constantly enter and upload each data field for an existing client in order to complete the application for financial products of each and every product provider.

In contrast, database server 16 (shown in FIG. 1) may be linked to any financial services provider to complete all of the required “paperwork” for that provider for the purpose of applying for the intended product or service. Database server 16 automates the application process, since database server 16 is configured to constantly update the forms requirements for each financial services provider and to use the data within database 14 to complete all required forms for each selected product instantly and in a secure environment. The described system therefore avoids the need to re-enter confidential data each time a new product is applied for, even if the new product is offered by a different financial services provider. For example, a client may request life insurance, a mortgage, and a mutual fund from any one or more of the supported providers without a need to reenter certain data to for each application. Database server 16 completes the application process using data from database 14 and provides linkages needed to obtain the electronic forms from each financial services provider.

By constantly updating forms requirements for each of the financial services providers, or vendors, database server 16 eliminates the possibility of old or inappropriate forms being used for the application process. For example, database server is configured to extract the appropriate forms and supporting information, for example, a prospectus or similar advisory information, from server 20 (shown in FIG. 1) via the internet. A similar process is used with respect to provider system 22 and secure interface 24. The extracted forms are matched against profiles of both the PSU and their clients to ensure that the forms selected are appropriate to both the PSUs and their clients, as well as compliant with all regulatory provisions governing the sale of that product. For example, licenses of the PSU are first evaluated before data from database 14 is formatted in a way so as to be processed into an application form. The license checking functions help assure compliance with state insurance laws, federal regulatory provisions and self-regulatory bodies.

After the forms and checking processes are completed, and the applications sent to the financial services provider, the completed forms may also be sent to a required entity. Many financial services products require the approval of advisory or regulatory bodies prior to the time of issuance. Database server is further configured with the appropriate regulatory entities based upon the profile of the PSU as well as the product that is being applied for. Highly regulated financial products typically require that certain disclosure information be provided. One example is a prospectus in the case of a securities product. Database server 16 maintains a log of all aspects of a transaction within database 14 to provide back-up documentation of all transactions. The logging provides an additional safeguard to the PSUs in the event of disputes between a PSU and any of their clients.

With a large database, for example, customer database 46, which contains such a large amount of client demographic and financial information, it is possible to develop software applications which utilize the information in customer database 46 to provide for customers an amount of financial planning and advice. In one embodiment, the financial planning is based upon a utilization of information in customer database 46 along with the tax code. In one embodiment, such a platform is provided and is sometimes referred to herein as a retirement plus platform.

In one embodiment, the retirement plus platform provides a computer based program product which is configured to provide financial planning with a goal to increase a client's after tax income. This goal is accomplished for clients by illustrating scenarios, based upon their financial and demographic information within customer database 46 (shown in FIG. 1) for transforming fully taxable retirement income into tax-advantaged retirement income, typically without incurring additional current cash flow obligations.

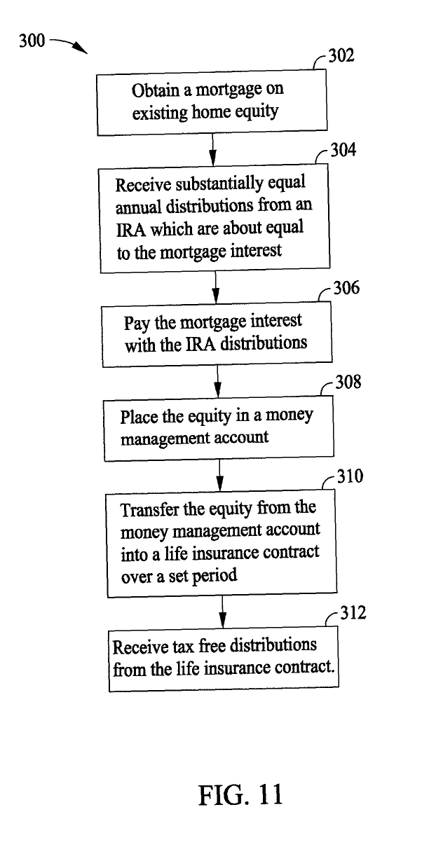

In one embodiment, the financial asset at the center of the retirement plus platform is a traditional, self-directed Individual Retirement Account (IRA) which often result from rolling over qualified plan money in conjunction with a change in employment. Such IRA's may also result through systematic funding by an individual over a period of time, as permitted under the tax code. The retirement plus platform is configured to match under-utilized equity in real property against the assets locked into the IRA accounts. A tax-advantaged approach to managing both resources is provided by retirement plus and, in many cases, can dramatically increase the net-after-tax income for individuals during their retirement years. Retirement plus further provides a platform for evaluation of such an approach and creates a framework, utilizing the stored information in customer database 46, for completing the steps necessary to implement the approach. In one embodiment, and as illustrated in FIG. 11 retirement plus provides a method 300 which includes obtaining 302 a mortgage on equity in a home, the mortgage having an annual interest amount. Further, substantially equal annual distributions from an individual retirement account that are approximately equal to the annual interest amount on the mortgage are received 304. Method 300 continues as the mortgage interest is paid 306 with the IRA distributions and the received equity is placed 308 in a money management account. The funds from the money management account are transferred 310 into a life insurance contract over a set period and tax free distributions are received 312 from the life insurance contract.

Since the retirement plus platform is resident in database server 16, the data from database 46 may be utilized with both loan providers as well as insurance companies, simplifying the process and allowing solutions to be created quickly. Retirement plus, in conjunction with system 10 allows a client and their PSU to quickly evaluate options and take decisive action. The moving pieces of mortgages, home equity loans, IRAs, and assorted life insurance products are all evaluated concurrently and take into consideration the changing environment of related federal tax rules. Additionally, once a decision is reached on the best approach to use and the best products have been selected to achieve a client's goals, then all required forms are generated and delivered to the providers (i.e. loan providers, insurance companies, and IRA plan administrators) as described above. The process ensures regulatory compliance and provides a documented archive of the transactions.

Retirement Plus is a tool used by properly licensed and registered securities professionals (herein referred to as PSUs), working in the presence of their individual clients. In the exemplary embodiment, the Client is provided a simplified explanation of the overall financial strategy which clarifies three fundamental concepts. One, the concept of deductible interest expense for persons filing itemized federal income tax returns. Two, the availability of penalty-free withdrawals from self-directed Individual Retirement Accounts (IRA's) according to the procedure of equal annual withdrawals. Three, the tax-advantaged income possibilities of various financial products, including life insurance products.

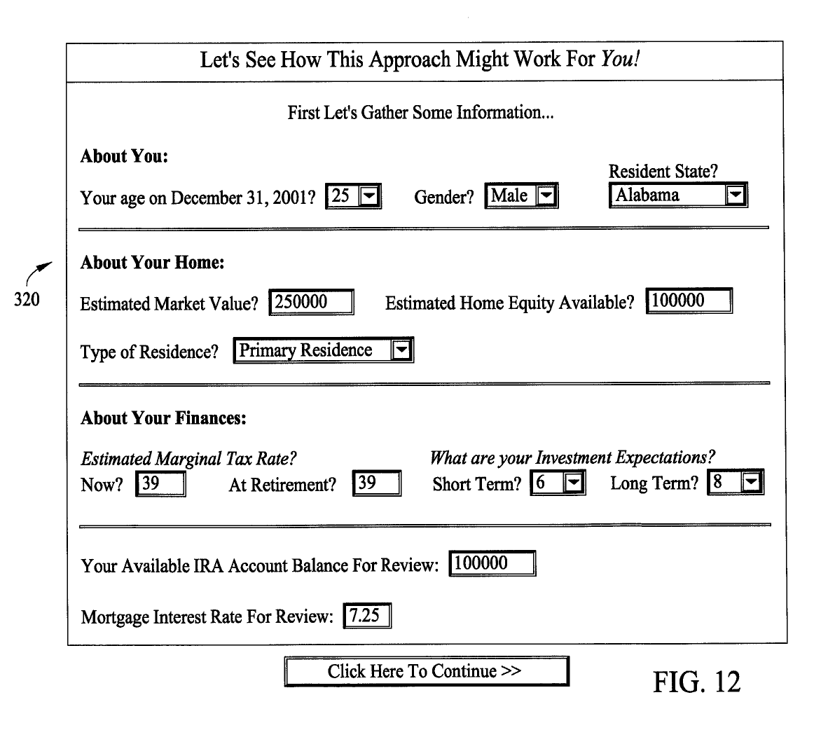

Referring to FIG. 12, a page 320 is illustrated which allows a client and PSU to evaluate possible financial strategies specific to the client's personal circumstances. Page 320 allows a PSU to enter certain financial and demographic information, as illustrated. However, it should be noted that the information may be automatically entered by database server 16, should any of the information be available within customer database 46. After data entry, database server 16 will evaluate the data, including a review of current financial resources and real estate holdings, current and projected future tax environments, and a review of goals desired for retirement income. Any newly entered information will be retained within database 46, as described above.

Data entered into page 320, in one embodiment, includes client age, client gender, and client's resident state. Also entered are an estimated fair market value of the client's home and the estimated home equity available, which is the current fair market value minus any 1st or 2nd mortgages. The home equity available may apply to either a first or second residence. The type of residence of residence is also entered, as are estimated present and future marginal tax rates and assumed future short-term rate of return IRA balances available at December 31st on the year preceding. This rate refers to the estimated rate of return to be earned in an account that is to be invested for a period of five years and systematically depleted to fund the long-term investment/life insurance product that the client selects.

An assumed future long-term rate of return is entered, which should be a realistic estimate of investment returns for a period spanning the client's present age to age 85. The client's IRA balance is entered for use in the retirement plus scenario as is an applicable interest rate for the mortgage product to be used. In one embodiment, retirement plus provides real-time market rates for comparable mortgage products. It should be noted that the data entered into page 320 is only going to provide a market estimate, not a bona fide mortgage offer.

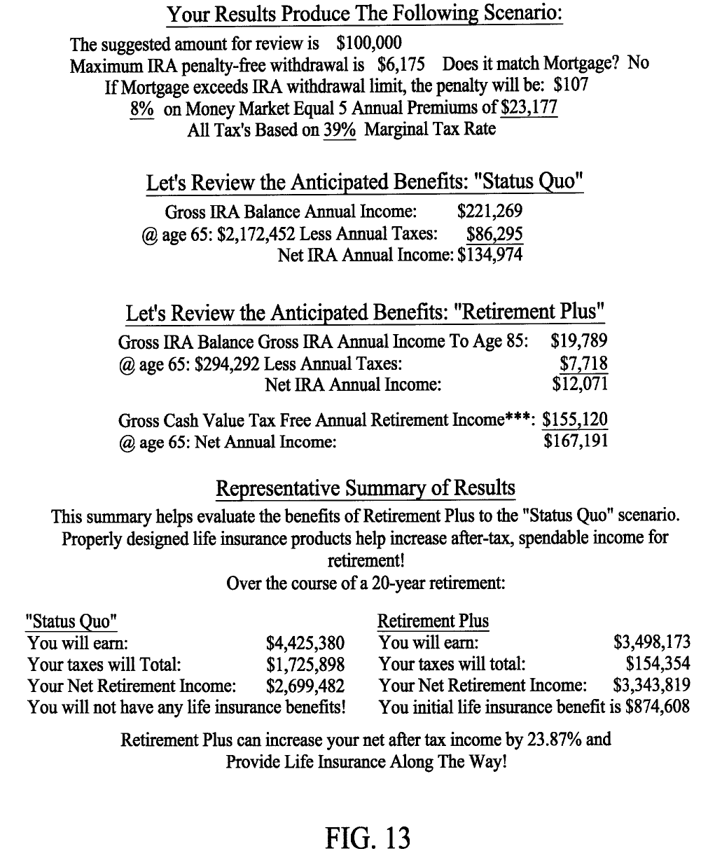

FIG. 13 is an illustration of a scenario 340 created using retirement plus running on database sever 16 for client review. It is to be noted that retirement plus computes a comparison table based upon a mortgage product that is assumed to be a 10-year, fixed rate loan that matures as a balloon. The balloon note is assumed to be rolled at maturity to a new 10-year fixed note in a process that continues to age 65. For analytical purposes, the balance of the balloon is computed to be repaid in the form of a lump-sum payment subtracted from the IRA balance remaining at age 65. In practice, this might not be the most tax-efficient approach to retiring the balloon note but such a treatment provides a simplified method for comparing alternatives.

Retirement plus evaluates the interest cost of the mortgage product versus the penalty free amount that may be withdrawn from an IRA when taken in the form of substantially equal annual withdrawals. Computations are based upon actual age projected for the close of the tax year in which an initial withdrawal is contemplated from the IRA. Calculations are based upon the annuity factor method using the IRS interest rate factors in effect at the time of the analysis. The withdrawal limit is compared to the interest expense deduction.

If the interest expense on the mortgage exceeds the penalty-free withdrawal amount allowed from the IRA under IRS interest rate factors in effect at the time of the analysis, then a penalty value is computed for the IRA withdrawal amount needed for interest expense after using the full amount of the penalty-free withdrawal limit. All computations are based upon the annuity factor method of distribution.

In one embodiment, computation of the permitted withdrawal amount is determined using an interest rate factor (the Applicable Federal Rate) that can and does change from month to month. Changes in such interest rates have an impact upon the amount that may be withdrawn. It should be understood that the amount of penalty-free withdrawal will depend upon the Applicable Federal Rate (or AFR) in effect at the time withdrawals commence, which might be a date in the future. For this reason, the actual amount of penalty-free withdrawals may vary somewhat from the amount shown in scenario 340, depending upon future changes in AFR as well as the actual day the client commences withdrawals from the IRA.

With retirement plus, database server 16 is configured to compare a difference between computed mortgage interest payments and an amount of penalty-free withdrawals from the IRA. If the mortgage interest is greater than the amount of penalty-free withdrawals, the retirement plus computes the estimated early withdrawal penalty on that portion of the withdrawal in excess of the permitted limit. The penalty is 10% of the withdrawal amount in excess of the substantially equal withdrawal amount. Any such withdrawal penalties, if applicable, are reported in scenario 340.

Retirement plus is further configured to compute a status quo scenario. This series of computations increases the IRA balance at the yield specified in the input section of the model. No taxes are withdrawn from IRA balances during the build-up period, which ends at age 65. The computed value for age 65 determines a 20-year income stream designed to completely liquidate the entire IRA balance at the end of the 20th year, assuming the long-term investment yield specified by the Client. A computation of a status quo IRA income stream is also made. The income stream previously computed will completely deplete the IRA during the period age 66 to age 85 and will end at age 86. During this entire period, ordinary income taxes are deducted using an estimated retirement tax rate. The computed annual income tax payments and the annual net-after-tax income are reported in scenario 340.

Computation of equal annual payments available to insurance product. Proceeds from the mortgage product are analyzed at the short-term yield specified by the client and the PSU. The net proceeds from the mortgage held in a short term investment account, pending re-investment into the long-term investment product. The strategy for the short-term investment account is a five year liquidation and fund transfer. The annual amount of the liquidation is computed to provide a first-year deposit to a life insurance contract or alternative investment product, and this amount is set to provide for four subsequent withdrawals in each of the next four years, each in an equal amount. The client can choose any periodic payment method, for example monthly, quarterly semi-annual or other method, as will effectively liquidate the funds over five years. This strategy produces a form of dollar cost averaging for funds paid into the insurance contract or long-term investment. The more frequent the deposits, the greater the effect of dollar cost averaging. Shortening the periodic liquidation interval will tend to reduce the total amount transferred out of the short-term investment account, but it will, on the other hand, fund the long-term account more rapidly and may produce better, overall results.

Retirement plus income is determined through a series of computations. Initially, a generic life insurance product is computed (as of the attained age of the Client), using a net rate of return as specified by the client in consultation with the PSU. The contract is assumed to be funded in the form of five equal annual installments, based upon the amounts of deposits created by liquidating the mortgage product, all as described above. Computations are based upon achieving a non-modified endowment contract status for the life insurance product, using the smallest face amount of insurance possible.

Withdrawal from the life insurance contract is in the form of an annual retirement benefit. Payments are computed in equal annual installments, commencing at age 66 and continuing through to age 85. The assumed net rate of return continues to be that specified by the client and the PSU. The client is not limited to an annual payment mode, and could choose to have the disbursements made on any periodic basis approved by the insurance carrier. Disbursements are computed, however, such that the contract is projected to remain in force to age 100 in order to protect the tax benefits of the life insurance contract. Therefore, the annual payments computed from the life insurance contract do not liquidate the available balances; rather, they are designed to withdraw annually the maximum amount possible that will leave the policy remaining in force.

In addition to annual income from the life insurance contract, potential income from the projected remainder balance of the IRA is added to determine overall retirement income. It is computed by determining the amount of equal annual payments that may be made for 20 years, at the assumed long-term net rate of return specified by the client and the PSU. This liquidation amount from the IRA will be taxable as ordinary income. Consequently, the computed liquidation amount is then reduced by the computed amount of taxes computed to be payable during retirement, using the marginal tax rate specified by the client. The tax rate used for calculations is the client's estimated marginal tax rate during retirement. The liquidation amount of the IRA, net of taxes, is added to the tax-advantaged income payable from the life insurance contract.

Retirement plus evaluates options based upon a marginal tax rate for a client both during the working portion of their lives as well as the rate forecasted during retirement. As used herein, marginal tax rate is defined within retirement plus as that combination of federal, state and local income tax applied to the last dollar of reportable income earned by the client during a tax period. For example, a client with a 28% federal income tax rate; a 3% state income tax rate; and a 1% local income tax rate would therefore use the combined rates (32%) as their effective marginal tax rate for computational purposes.

For reference, and referring to scenario 340, gross IRA balance at age 65 means the projected cash value in the IRA account, after all planned annual transfers, and assuming a net rate of return as specified by the client. Gross IRA annual income to age 85 means the amount of annual withdrawals from the IRA as will liquidate the IRA during the period age 65 through age 85. Less annual taxes means the computed income taxes due as a result of the withdrawals described above, at the marginal tax rate specified by the client during the retirement years. Net IRA annual income means the gross distribution less the annual taxes, described above. Gross cash value means the projected cash value within a typical life insurance contract at age 65, using the investment assumptions described above. Tax free annual retirement income means the amount of annual withdrawals from a typical insurance contract which may be made from ages 65 through age 85, such that the remaining projected balance will leave the policy remaining in force to age 100. Net annual income means the combination of the net-after-tax IRA withdrawal added together with the tax-free annual retirement income, as described above. Comparison of the status quo to retirement plus within scenario 340 is based upon the computation factors above. Each subsequent re-computation assumes that initial inputs for age, gender and state of residence remain constant. By allowing a range of values to be specified, the client and PSU can examine alternative scenarios.

An overall summary of results within scenario 340 contains the following information: projected earnings during retirement for both status quo and retirement plus, projected total tax payments during retirement years, projected net retirement income, and a percentage comparison of projected net retirement incomes.

Retirement plus calculates the amount of penalty-free withdrawals from an IRA account using an annuity factor method which is one of three permitted methods acceptable under IRS rules. The annuity factor method is used due to the fact that it typically produces a larger amount that may be withdrawn without penalties compared to the other two techniques. An important consideration of the annuity factor method is that it is based upon the applicable federal rate or AFR in effect at the time that withdrawals are commenced from an IRA. The AFR permitted under IRS guidelines is 120% of the mid-term AFR, which is published each month within IRS publications. Database server 16 is constantly updated to use the most current AFR rates available. Actual commencement of the withdrawal process from the IRA locks-in the AFR during the entire withdrawal period. Because the review process might not coincide precisely with the initial withdrawal, the AFR might change during the period between the review and the actual commencement of withdrawals. In the event the AFR changes during this intervening period, the amount that might be withdrawn from the IRA on a penalty-free basis may change. In most circumstances, any such rate changes have only a minor impact on the amount of penalty-free withdrawals. However, rapidly changing interest rate environments or protracted periods of time between the review process and the actual commencement of withdrawals can have potentially significant impacts as future changes in interest rates are unpredictable. A second important consideration is that AFR's are related to the interest rate environment for US Treasury securities.

What follows is a brief description of one set of pages or screens used for collection of information and selection of products regarding mortgages products, IRA accounts, and life insurance products with respect to the above described methods. The pages are for illustration only, as many variations are possible within the scope of the invention. The pages allow input for collection of basic information needed to complete all of the life insurance, investment product and mortgage product applications. It is to be understood that the pages illustrated herein are not intended to circumvent any applicable regulatory requirements. The regulatory requirements may require submission of additional documents that are associated with a particular financial product. Further, in the embodiment illustrated, it is important to note that during data collection, information is held in a session for the specific Client, and stored in customer database 46. Data is not interchanged with any life insurance company, long term investment provider, or with the mortgage product provider during data collection. Therefore, it is possible, to suspend the session if key data is not available. Once the key data becomes available, the data collection can be restarted, while utilizing the previously collected data in customer database 46.

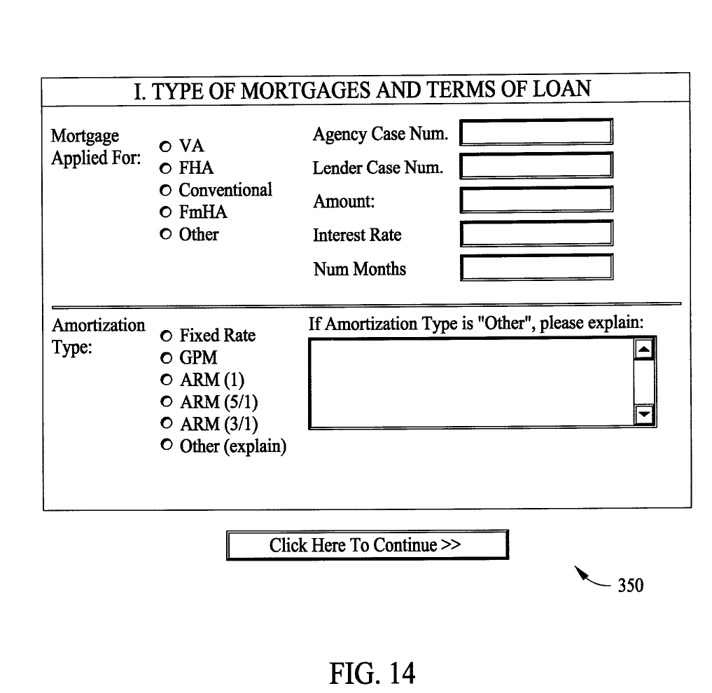

FIG. 14 illustrates a page 350 for selection of a type of mortgage and terms of the loan associated with the mortgage. An agency case number is the client's social security number. Lender case number will be assigned later by the mortgage provider to be selected. Amount is the total amount of the mortgage product to be applied for. The amount might include a new mortgage amount or, alternatively, the mortgage amount together with the equity amount desired. An interest rate is to be specified by the PSU. Number of months is the requested duration of the mortgage product. Amortization type is selected from the choices or other may be specified, provided that a description is provided in the available box, e.g., interest only balloon—10 years, etc.

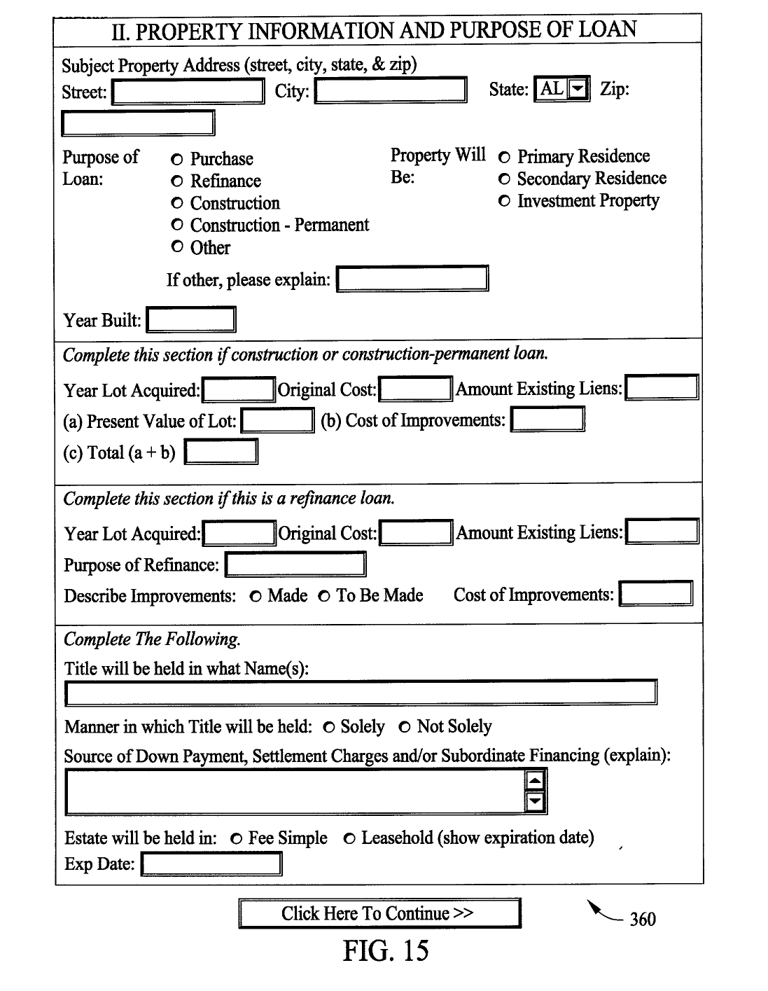

FIG. 15 illustrates a page 360 for entry of property information and purpose of loan. Page 360 allows a PSU to describe the property to be financed, refinanced or made part of an equity credit line. Page 360 includes the address of the property. Further, selections are entered that describe a purpose of loan, for example, purchase, refinance, or construction, and describe a property type, for example, primary residence, secondary residence, or investment property. Other information for an adequate description of the property for purposes of a loan is entered through page 360. A sampling of the information to be entered includes a year constructed, how the title of the property is to be held, and source of down payment.

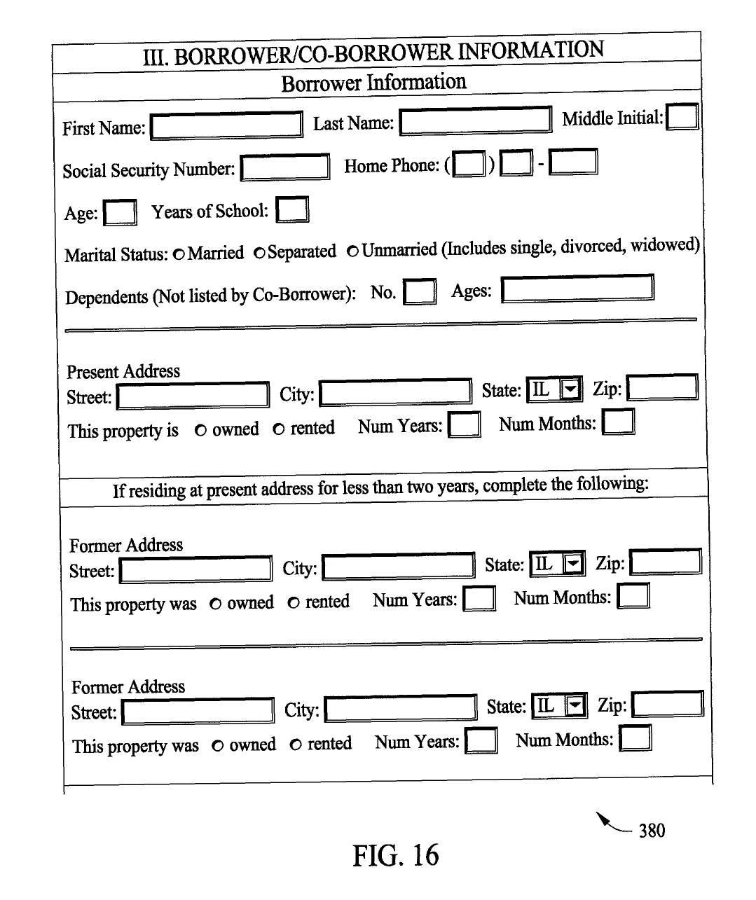

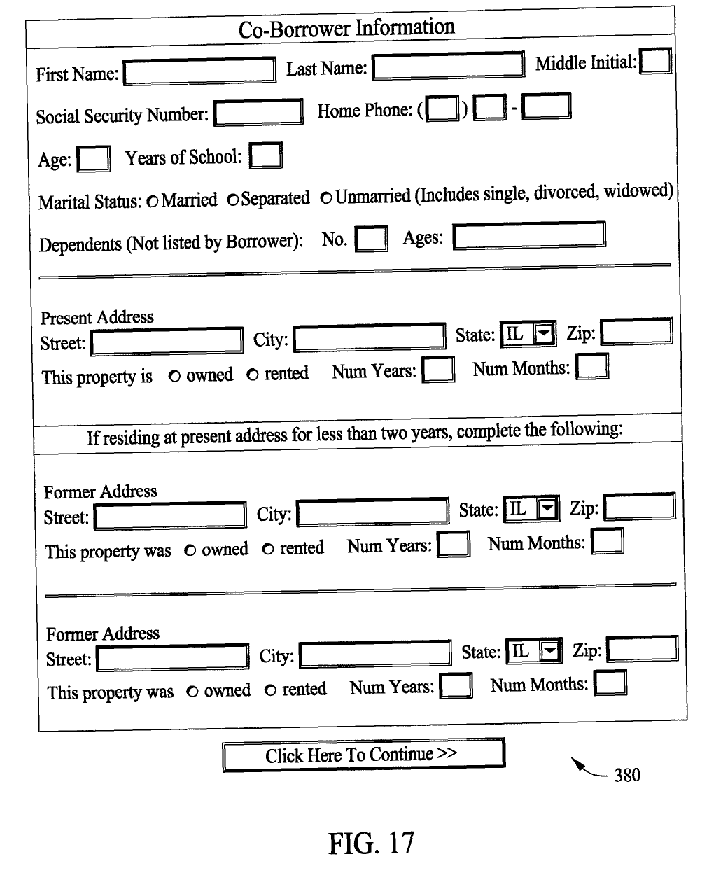

FIGS. 16 and 17 illustrate a page 380 for entry of borrower and co-borrower information, for example, names, addresses, telephone numbers, ages, marital status, and social security numbers. Page 380 allows a description of the individual(s) that will be securing the loan to be entered and stored in database 46. In one embodiment, the Social Security Number of the borrower becomes an identification code which may be subsequently used to retrieve the client's file from customer database 46.

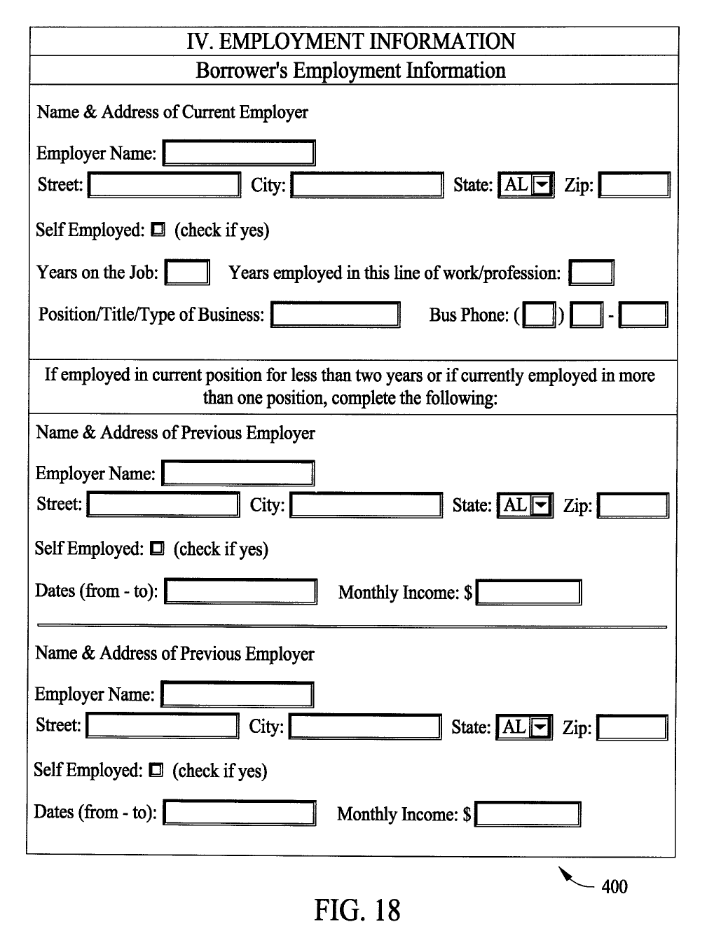

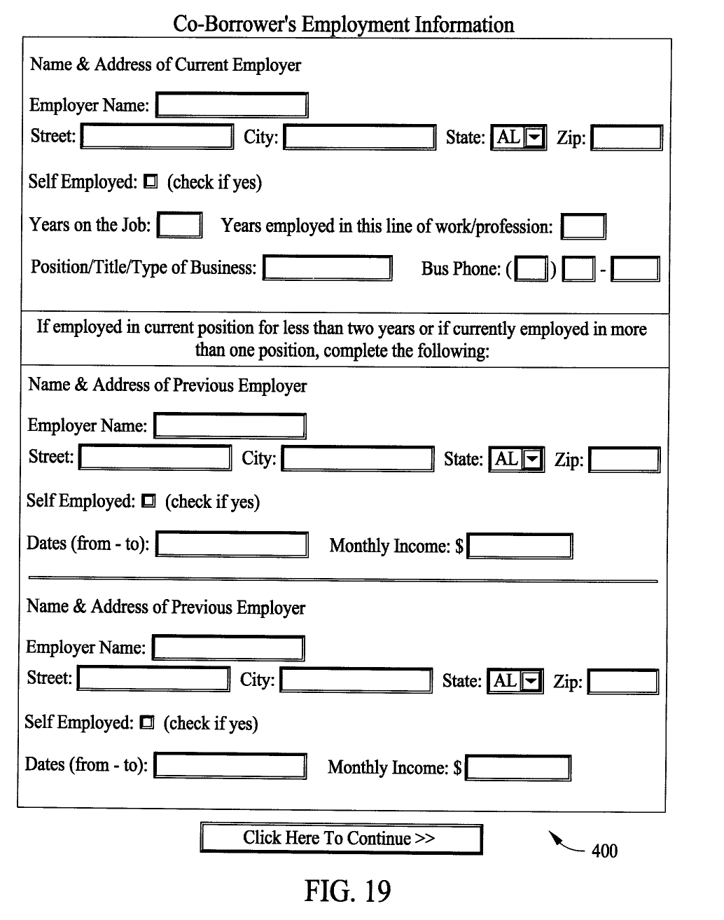

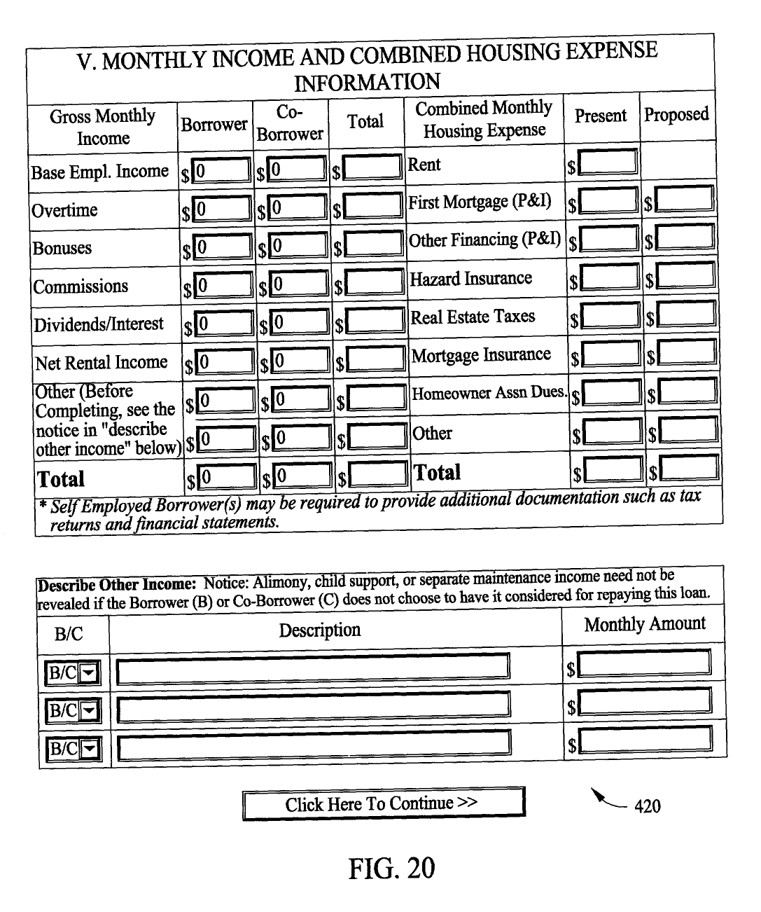

FIGS. 18 and 19 illustrate a page 400 where the PSU can enter borrower and co-borrower employment information, for example, employer name, address, business telephone, and employment history, for storage into customer database 46. FIG. 20 illustrates a page 420 for entry of monthly income and combined housing expense information for both the borrower and co-borrower. Page 420 also is configured for entry of additional income from sources other than employment.

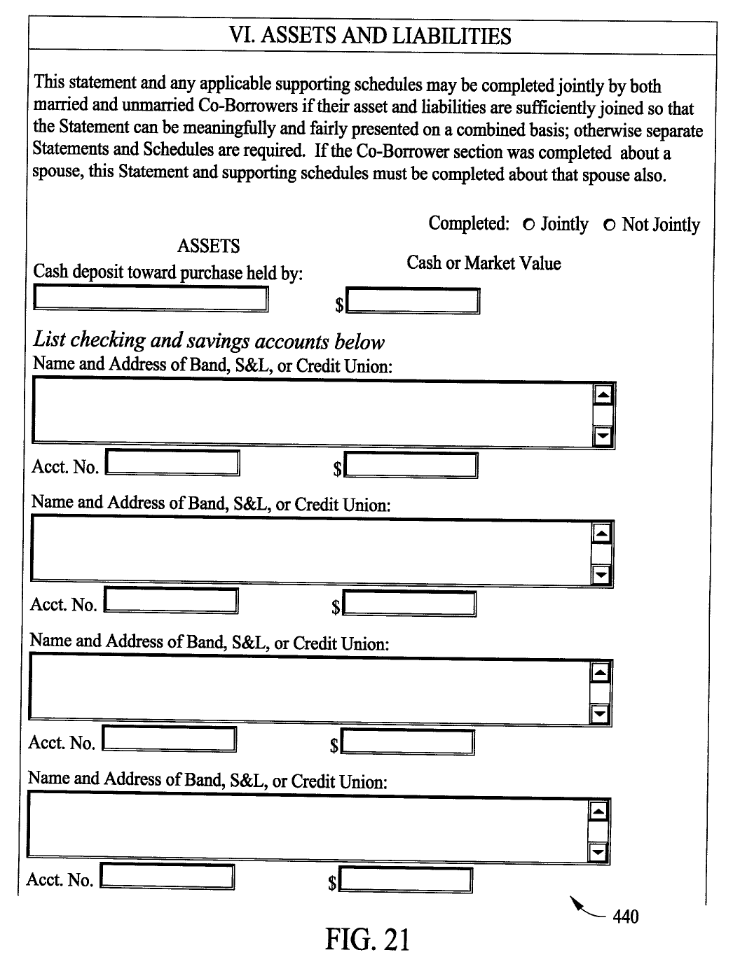

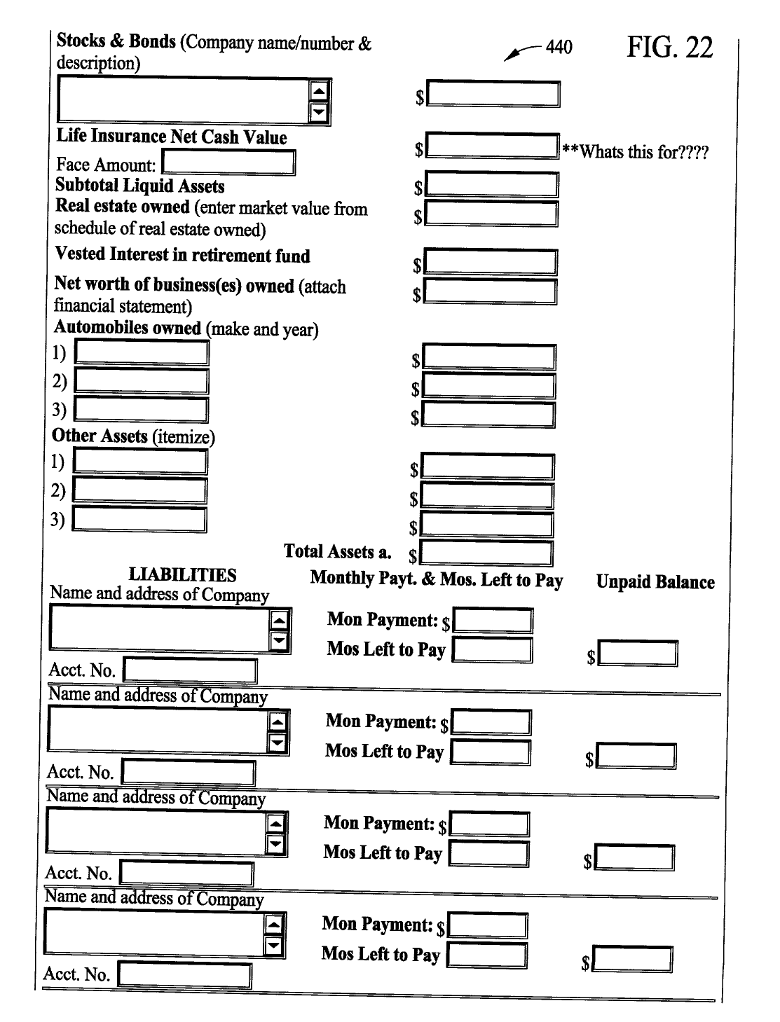

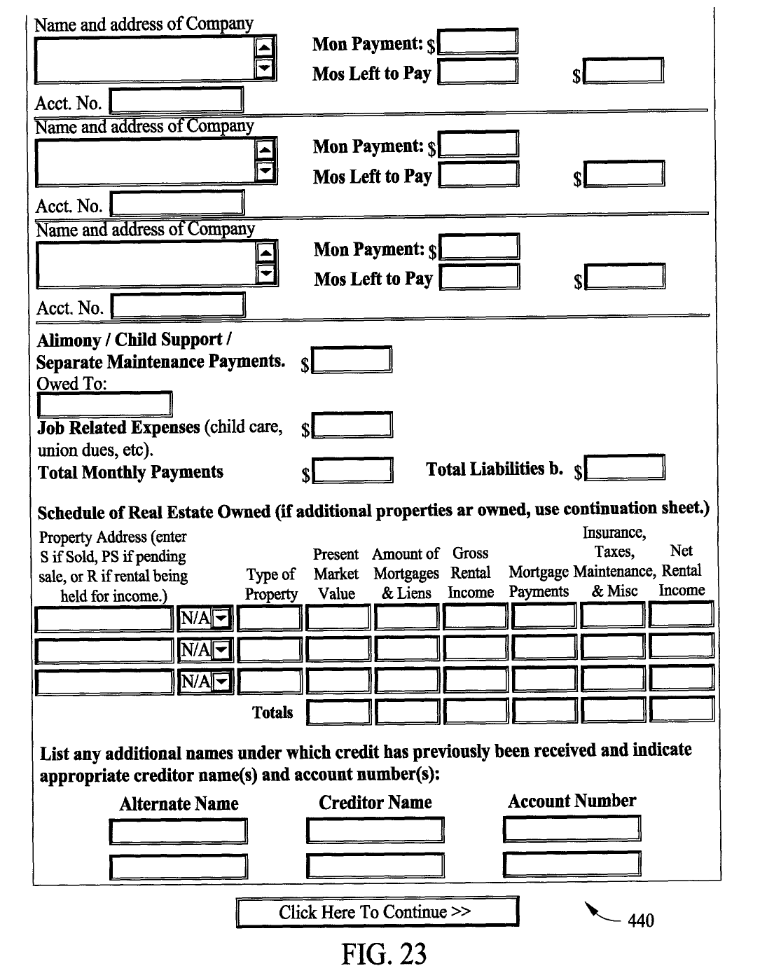

FIGS. 21 through 23 are an example of a page 440 where the PSU can enter asset and liability information on the borrower and co-borrower for storage into customer database 46. Entry of data into page 440 provides detailed information which allows completion of an asset and liability chart and a complete basic balance sheet. Such asset and liability information includes, but is not limited to, cash, banking type accounts, life insurance, real estate, automobiles, credit cards and real estate.

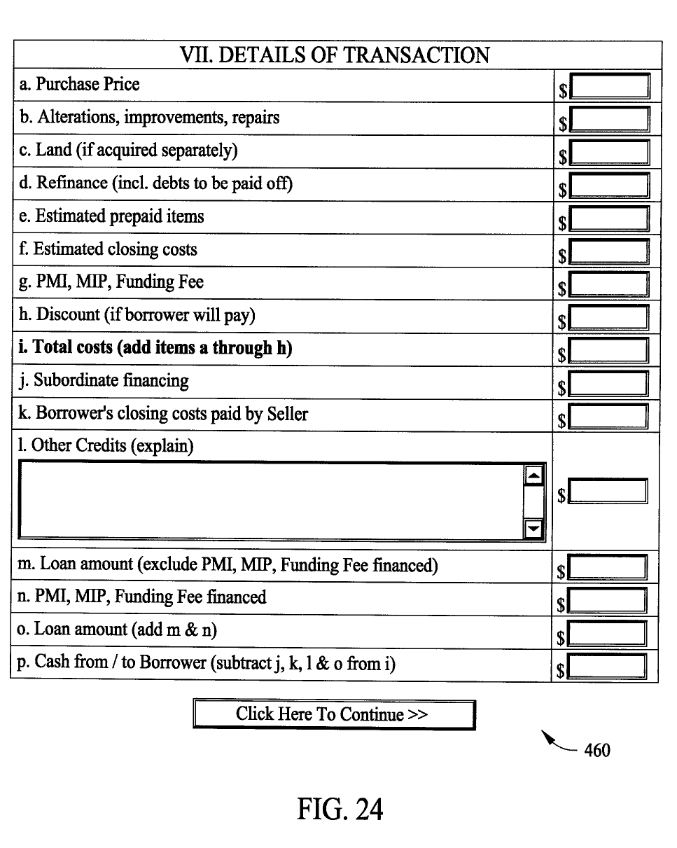

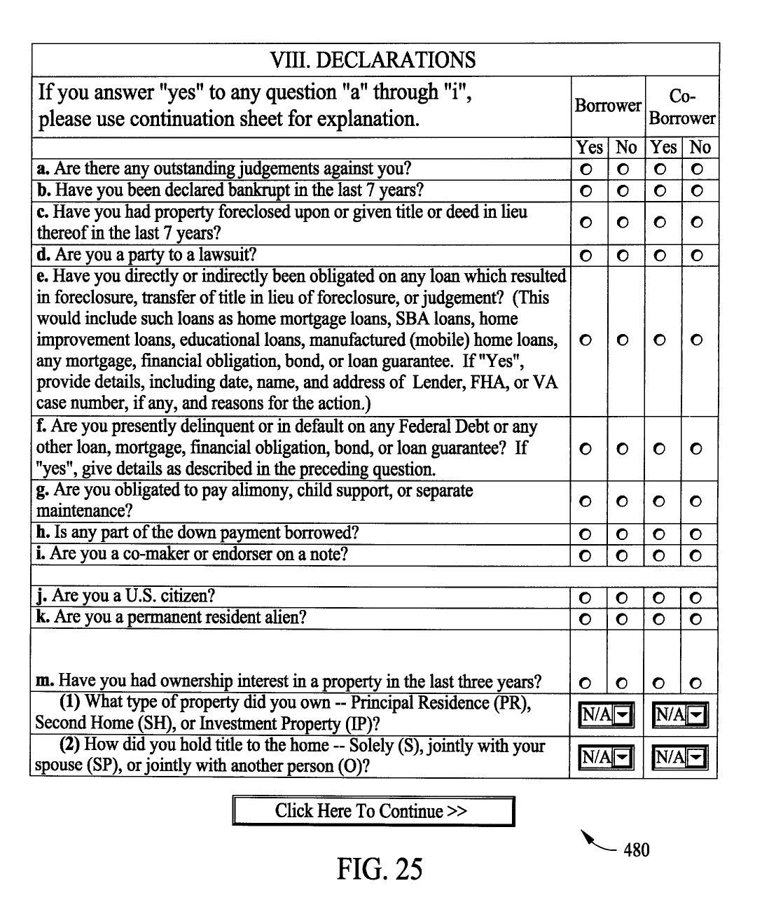

FIG. 24 is a page 460 which illustrates details of a real estate transaction by providing detailed information for estimates of transaction closing costs and expenses. In certain embodiments, a mortgage provider provides the data for entry into page 460. FIG. 25 is a declarations page 480 through which are entered answers to questions regarding the borrower and co-borrower, for example, if there are outstanding judgements against either, or if either has declared bankruptcy within a given time frame.

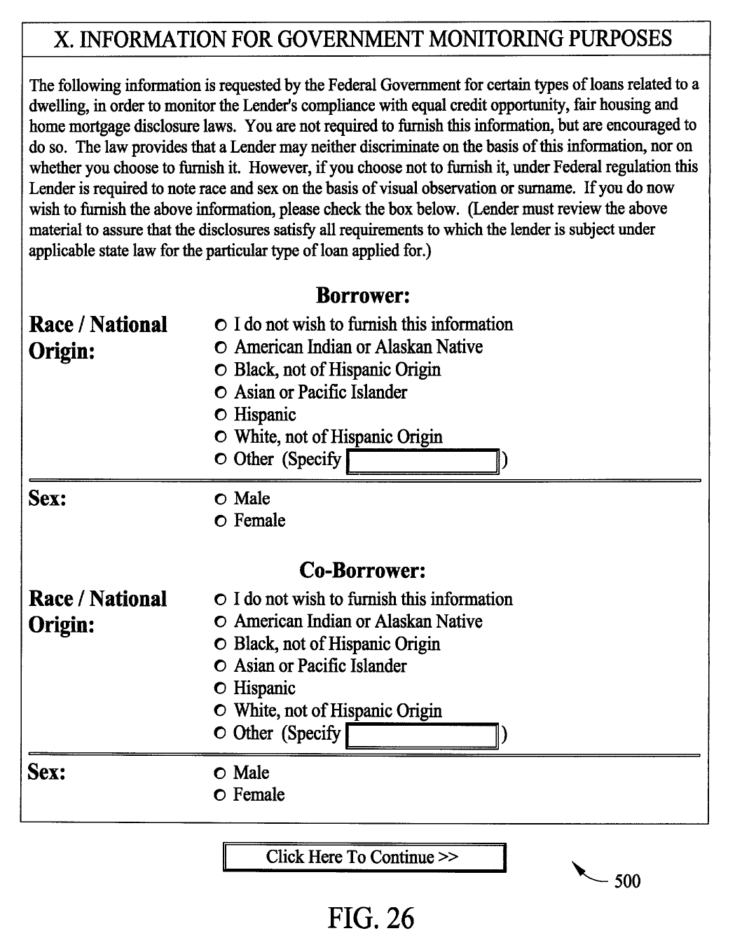

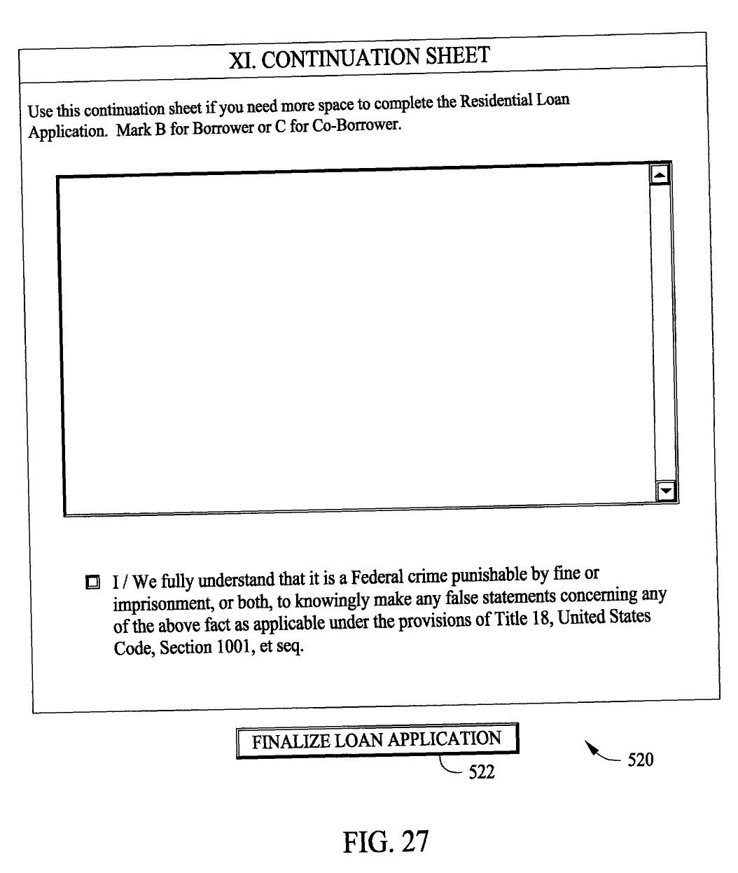

FIG. 26 is a governmental monitoring page 500, where a client may input optional information, for example, race and sex of the borrower and co-borrower, which, if submitted, is utilized for governmental monitoring purposes. FIG. 27 is a page 520 illustrating a continuation sheet which provides additional space to answer any questions raised on any of the previously described pages or to add any comments or information which might be useful to the mortgage underwriter. Page 520 further contains a button 522, which, upon review and approval is selected to complete the mortgage application.

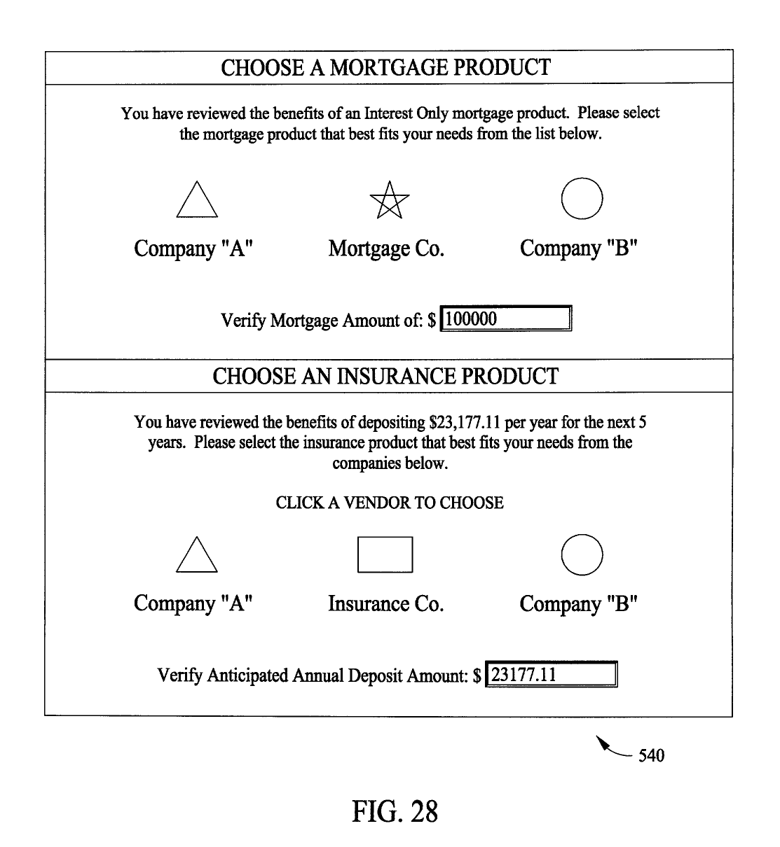

FIG. 28 is a page 540 which allows a client to review and select a mortgage product and an insurance product. Page 540 includes a recap of the last scenarios evaluated by the client including information regarding the size of the mortgage product previously being evaluated. At this time the client may elect to enter a new amount for the mortgage product. If a new amount is entered, it becomes the amount of the mortgage loan that will be applied for at the time of submission.

Page 540 also allows a client to select an insurance product. An amount displayed on page 540 is the anticipated annual deposit amount to be paid into the life insurance contract over, for example, a following 5-year period. If the amount displayed is satisfactory, this becomes the amount to be used for purposes of running an actual life insurance policy illustration. If an alternative amount is entered by the client, this amount is inserted into the policy illustration.

As described above, the client is also able to select a life insurance product as well as the specific life insurance company to provide the selected product. The available choices of life insurance contracts presented to the client are determined by the contractual arrangements of the PSU. All such contractual arrangements are held in individual registration profiles for each PSU. Once the client has made the specific insurance product selections, and once all the information for application for the life insurance product is gathered, the actual submission will be made for the life insurance product and the mortgage product. As previously described, it is contemplated that the majority of such information is extracted from customer database 46.

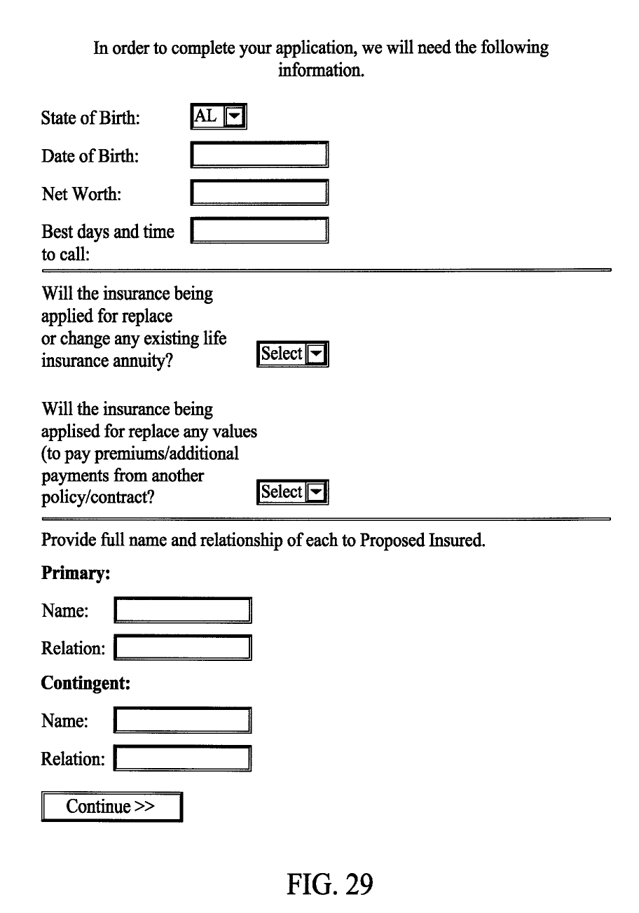

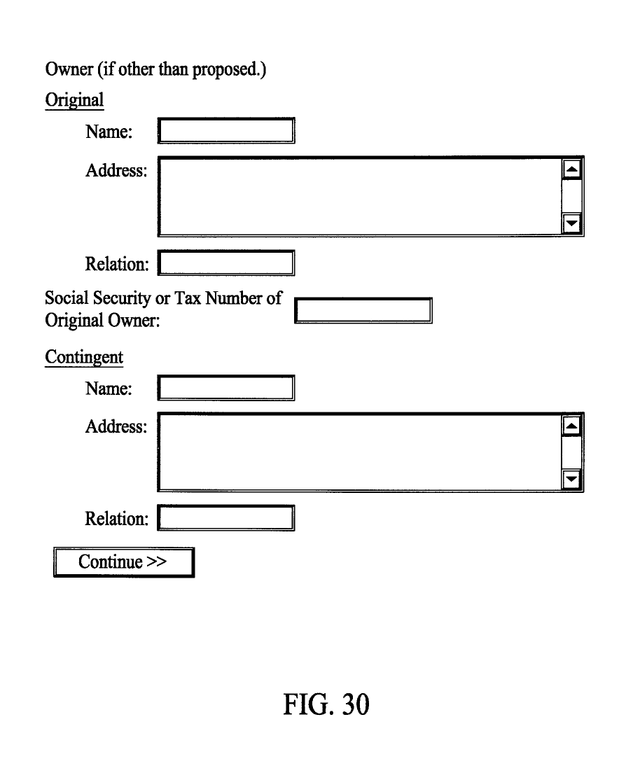

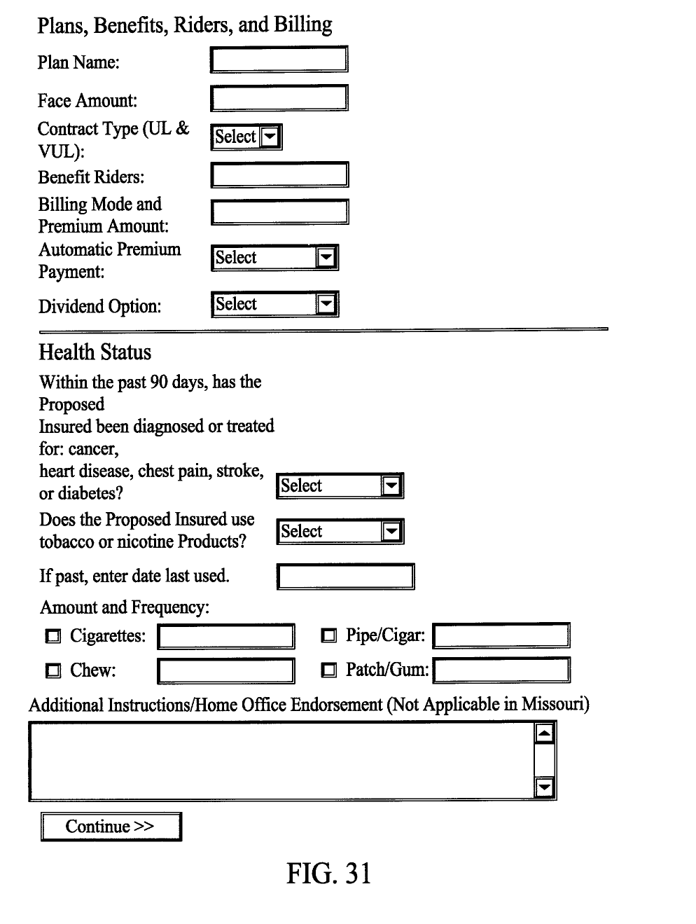

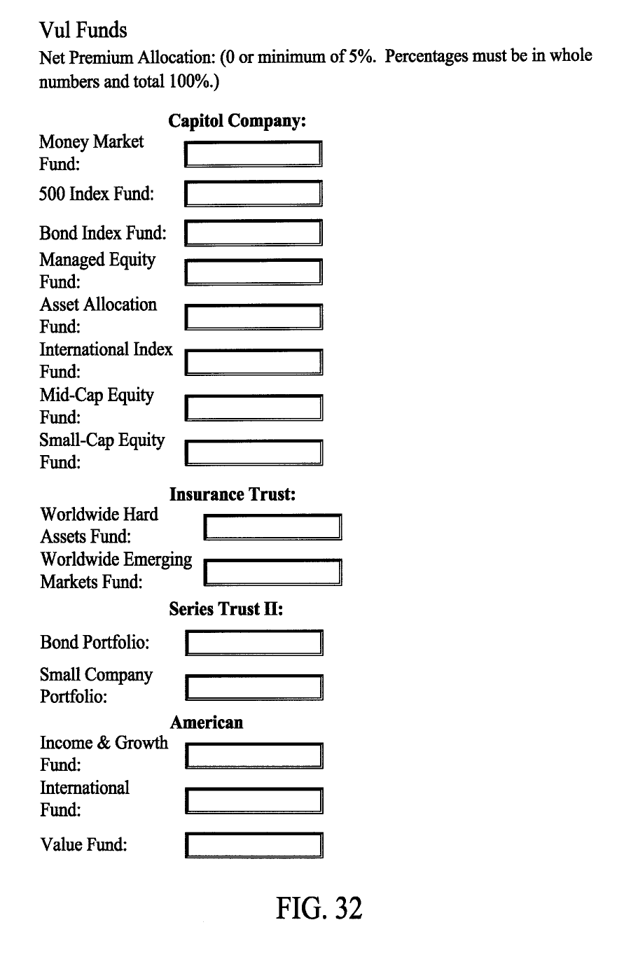

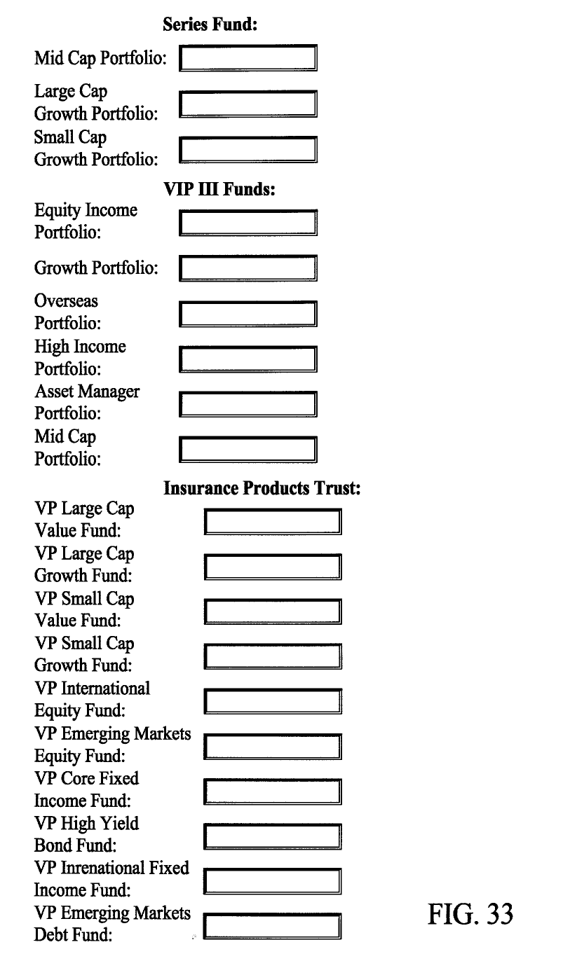

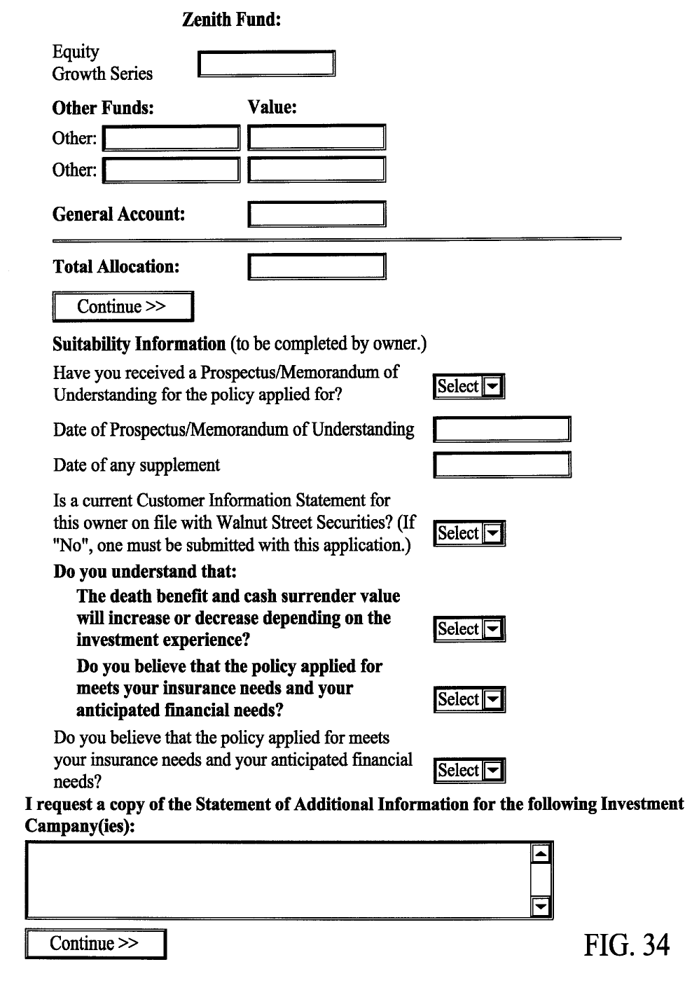

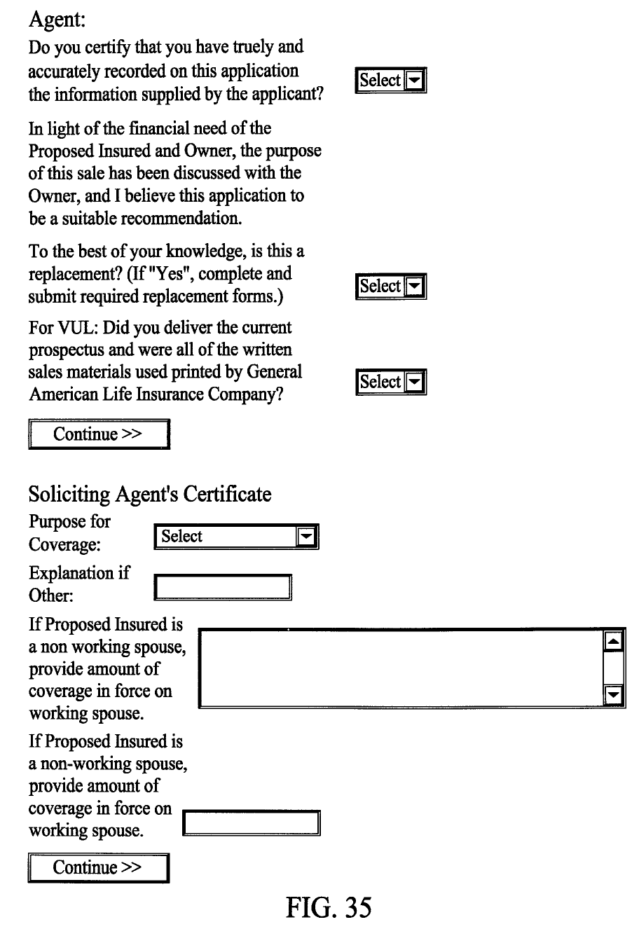

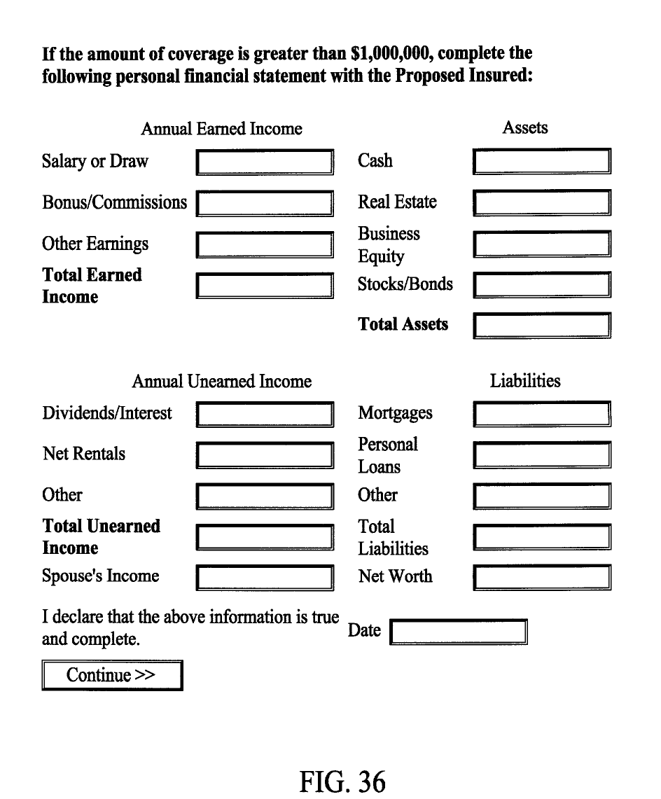

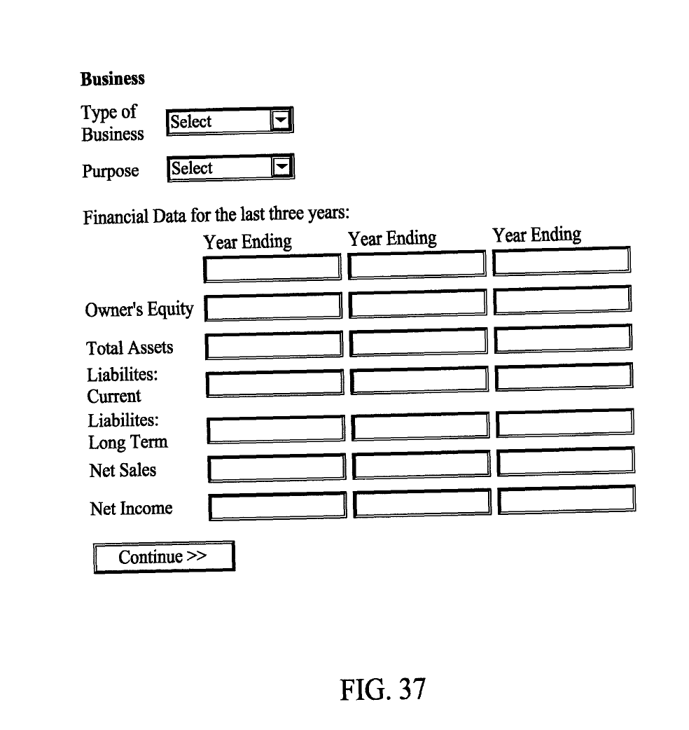

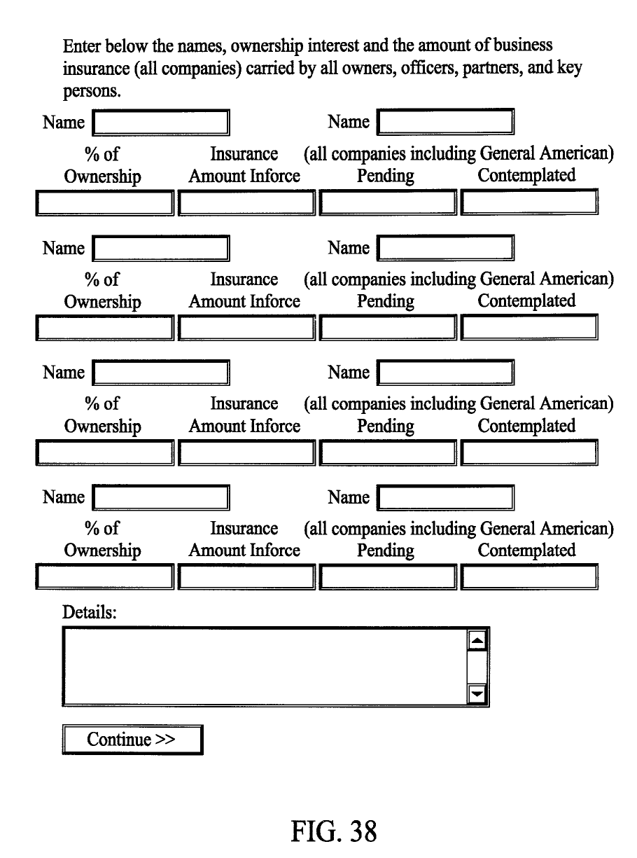

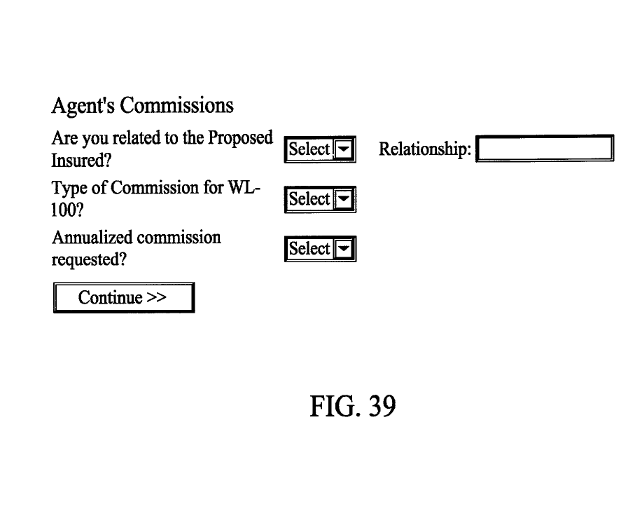

FIGS. 29 through 39 are one example set of pages which form an application for a life insurance product. The fields within the pages are filled with application information that is gathered from customer database 46, should the data exist within database 46. Any information that is not contained within customer database 46 is entered manually to complete the application for the life insurance product. Any application which is entered manually becomes stored within database 46 for future product purchases.

The provider of the mortgage product contacts the client in the event that any additional information is required to complete the application process and for setting up a closing time for the mortgage. The provider of the life insurance product contacts the client to complete any additional information as may be needed to complete the life insurance application process, for example, scheduling of any blood, urine, HOS, or other such specimens together with any paramedic or attending physician examinations and questions as may be customarily required for the issuance of a policy of life insurance.

While the invention has been described in terms of various specific embodiments, those skilled in the art will recognize that the invention can be practiced with modification within the spirit and scope of the claims.

What is claimed is:

1. A method for increasing after tax income comprising:
obtaining a mortgage on equity in real property, the mortgage having an annual interest amount;
receiving substantially equal annual distributions from an individual retirement account that are approximately equal to the annual interest amount on the mortgage;
paying the mortgage interest with the IRA distributions;
placing the received equity in a money management account;
transferring funds from the money management account into a life insurance contract over a set period; and
receiving tax advantaged distributions from the life insurance contract.

2. A method according to claim 1 wherein the set period is five years.

3. A method according to claim 1 wherein the life insurance contract is limited to the smallest death benefit possible that is adequate to accept the transferred funds without the contract becoming a modified endowment contract.

4. A computer program product for use with a computer system, the computer program product comprising a computer usable medium having code stored thereon comprising:
program code for matching equity in real property against assets in IRA accounts;
program code for illustrating how withdrawals from the IRA can be used to pay a mortgage taken on the equity in real property; and
program code for illustrating how proceeds from the taken mortgage can be utilized in a tax advantaged insurance product.

5. A computer program product according to claim 4 comprising program code for comparing estimated income and taxes for an insurance product purchased with mortgage proceeds against estimated income and taxes from an IRA.

6. A computer program product according to claim 5 wherein said program code compares estimated income and taxes over a 20 year retirement period.

7. A computer program product according to claim 5 further comprising program code which utilizes an estimated marginal tax rate for comparing estimated income and taxes.

8. A computer program product according to claim 4 comprising program code for determining a penalty amount if a mortgage payment amount exceeds a maximum IRA withdrawal limit for substantially equal annual withdrawals.

9. A computer program product according to claim 4 comprising program code for facilitating mortgage applications and insurance applications.

10. A computer program product according to claim 9 comprising program code for retrieving information needed for the mortgage and insurance applications from a database.

11. A computer program product according to claim 9 comprising program code for formatting mortgage application data into an electronic format acceptable for receipt by a selected mortgage provider.

12. A computer program product according to claim 9 comprising program code for formatting insurance application data into an electronic format acceptable for receipt by a selected insurance provider.

13. A financial planning system, comprising:
a database of customer financial and demographic data;
a database server configured to write data to and read data from said database; and
a computer configured to access said database server, said database server further configured to match equity in the real property of a customer against assets in IRA accounts of the customer, illustrate how substantially equal withdrawals from the IRA over a set period can be used to pay a mortgage taken on the equity in the real property, and illustrate how proceeds from the taken mortgage can be utilized in a tax advantaged insurance product to increase after tax income.

14. A financial planning system according to claim 13 wherein said database server is further configured to compare estimated income and taxes for an insurance product purchased with mortgage proceeds against estimated income and taxes from an IRA.

15. A financial planning system according to claim 14 wherein said database server is further configured to combine estimated income and taxes for the insurance product with estimated income and taxes from a projected remainder balance of the IRA for comparison to estimated income and taxes from the IRA.

16. A financial planning system according to claim 14 wherein said database server is further configured to compare the estimated incomes and taxes over a 20 year retirement period.

17. A financial planning system according to claim 13 wherein said database server is further configured to utilize an estimated marginal tax rate for comparing estimated incomes and taxes.

18. A financial planning system according to claim 13 wherein said database server is further configured to determine a penalty amount if a mortgage payment amount exceeds a maximum IRA withdrawal limit for substantially equal annual withdrawals.

19. A financial planning system according to claim 13 wherein said database server is further configured to facilitate mortgage applications and insurance applications.

20. A financial planning system according to claim 19 wherein said database server is further configured to retrieve data needed for the mortgage and insurance applications from said database.

21. A financial planning system according to claim 20 wherein said database server is further configured to format mortgage application data into an electronic format acceptable for receipt by a selected mortgage provider.

22. A financial planning system according to claim 20 wherein said database server is further configured to format insurance application data into an electronic format acceptable for receipt by a selected insurance provider.

23. A financial planning system according to claim 13 wherein said database server is further configured to:
compare multiple mortgages, home equity loans, IRAs, current and future projected tax environments, and insurance products; and
determine a combination of the mortgages, loans, IRAs, and insurance products that achieve customer goals.

24. A financial planning system according to claim 23 wherein said database server is further configured to select insurance products which maintain a non-modified endowment contract status.

25. A financial planning system according to claim 13 wherein said database server is further configured to provide a documented archive and regulatory compliance.

26. A financial planning system according to claim 13 wherein said computer is configured to access said database server over the Internet.
